(19) United States
(12) Patent Application Publication
(10) Pub. No.: US 2026/0136241 A1
(43) Pub. Date: May 14, 2026

(54) TRAFFIC INTERLEAVED TIME SPREAD MULTIPLE ACCESS (TILTSMA)

(71) Applicant: RTX BBN Technologies, Inc., Cambridge, MA (US)

(72) Inventors: Dylan Joseph Cirimelli-Low, Santa Cruz, CA (US); Colin Fumito Funai, Whiteland, IN (US)

(21) Appl. No.: 19/365,488

(22) Filed: Oct. 22, 2025

Related U.S. Application Data
(60) Provisional application No. 63/720,279, filed on Nov. 14, 2024.

(51) Int. Cl. H04W 28/26; H04L 5/00; H04W 72/0446

(52) U.S. Cl. CPC H04W 28/26; H04L 5/0051; H04W 72/0446

(57) ABSTRACT

A method includes transmitting, by a first node during a first instance of a first timeslot allocated to the first node, a reservation associated with transmitting a set of data packets, transmitting, by a second node during a first instance of a second timeslot allocated to the second node, the reservation to one or more relay nodes which are within a threshold distance of the second node, temporarily reallocating resources from the one or more relay nodes to the first node based on the reservation, transmitting, by the first node during a first instance of a third timeslot, a first data packet of the set of data packets to the second node, transmitting, by the second node during a second instance of the second timeslot, the first data packet to a first relay node, and transmitting, by the first relay node, the first data packet toward the destination node.

### CROSS-REFERENCE TO RELATED APPLICATIONS

This application claims the benefit of U.S. Application No. 63/720,279 filed Nov. 14, 2024, the disclosure of which is incorporated herein by reference in its entirety.

### GOVERNMENT LICENSE RIGHTS

This disclosure was made with Government support under HR0011-21-C-0129 awarded by DARPA. The Government has certain rights in the disclosure.

### BACKGROUND

The present disclosure relates to communications scheduling in wireless networks, and, in particular, to traffic interleaved time spread multiple access (TILTSMA) communications scheduling in wireless networks.

In some approaches, time-division multiple access (TDMA) scheduling may either be inefficient (e.g., role-based or round-robin). For cases of optimized TDMA scheduling, the optimized TDMA scheduling may be limited to a specific topology (e.g., manual slot assignment).

### BRIEF DESCRIPTION

Disclosed are systems and methods that can be used for generating schedules for transmitting and receiving data.

Embodiments of the present disclosure are directed to a method of transmitting data to a destination node over a communications network, including: transmitting, by a first node during a first instance of a first timeslot allocated to the first node from among a set of timeslots, a reservation associated with transmitting a set of data packets to the destination node; transmitting, by a second node during a first instance of a second timeslot allocated to the second node from among the set of timeslots, the reservation to one or more relay nodes which are within a threshold distance of the second node from among relay nodes of the communications network; temporarily reallocating resources from the one or more relay nodes to the first node based on the reservation, wherein the resources are associated with a third timeslot among the set of timeslots; transmitting, by the first node during a first instance of the third timeslot, a first data packet of the set of data packets to the second node; transmitting, by the second node during a second instance of the second timeslot, the first data packet to a first relay node included among the relay nodes of the communications network; and transmitting, by the first relay node during a second instance of the third timeslot, the first data packet toward the destination node.

In any one or combination of the embodiments disclosed herein: the resources which are temporarily reallocated from the one or more relay nodes to the first node based on the reservation are further associated with a fifth timeslot among the set of timeslots; and the method further includes transmitting, by the first node during a first instance of the fifth timeslot, a second data packet of the set of data packets to the second node.

In any one or combination of the embodiments disclosed herein, the method further includes: transmitting, by a second relay node included among the relay nodes of the communications network during a second instance of the fifth timeslot, the first data packet toward the destination node, transmitting, by the second node during a third instance of the second timeslot, the second data packet to the first relay node; transmitting, by the first relay node during a third instance of the third timeslot, the second data packet toward the destination node; and transmitting, by a third relay node included among the relay nodes of the communications network during the third instance of the third timeslot, the first data packet toward the destination node.

In any one or combination of the embodiments disclosed herein, the reservation includes an indication of a quantity of instances of the third timeslot and a quantity of instances of the fifth timeslot for which the resources are to remain reallocated to the first node.

In any one or combination of the embodiments disclosed herein, the method further includes reallocating the resources to the one or more relay nodes, after the first node has completed transmitting the set of data packets to the second node.

In any one or combination of the embodiments disclosed herein, the method further includes transmitting, by the first node during a second instance of the first timeslot, a final data packet of the set of data packets to the second node.

In any one or combination of the embodiments disclosed herein, the method further includes transmitting, by a further relay node which is included among the relay nodes of the communications network and neighbors the destination node, the first data packet to the destination node, wherein: the transmitting of the first data packet by the first node to the second node is according to a first communications protocol; the transmitting of the first data packet by the second node to the first relay node is according to a second communications protocol different from the first communications protocol; and the transmitting of the first data packet by the further relay node to the destination node is according to the first communications protocol.

In any one or combination of the embodiments disclosed herein, the method further includes transmitting, by the second node during the first instance of the second timeslot, an acknowledgement message to the first node with respect to the reservation.

In any one or combination of the embodiments disclosed herein, the method further includes: transmitting, by a relay node which is included among the relay nodes of the communications network and neighbors the destination node, a data packet of the set of data packets during a subsequent instance of the third timeslot or a subsequent instance of a fifth timeslot among the set of timeslots; and receiving, by the destination node, the data packet.

Embodiments of the present disclosure are also directed to a system including: a first node; a second node; a destination node; and a communications network including relay nodes, wherein the relay nodes are between the second node and the destination node; wherein: the first node is configured to transmit, during a first instance of a first timeslot allocated to the first node from among a set of timeslots, a reservation associated with transmitting a set of data packets to the destination node; the second node is configured to transmit, during a first instance of a second timeslot allocated to the second node from among the set of timeslots, the reservation to one or more relay nodes which are within a threshold distance of the second node from among the relay nodes of the communications network; the one or more relay nodes are configured to temporarily reallocate resources to the first node based on the reservation, wherein the resources are associated with a third timeslot among the set of timeslots; the first node is further configured to transmit, during a first instance of the third timeslot, a first data packet of the set of data packets to the second node; the second node is further configured to transmit, during a second instance of the second timeslot, the first data packet to a first relay node included among the relay nodes of the communications network; and the first relay node is further configured to transmit, during a second instance of the third timeslot, the first data packet toward the destination node.

In any one or combination of the embodiments disclosed herein: the resources which are temporarily reallocated from the one or more relay nodes to the first node based on the reservation are further associated with a fifth timeslot among the set of timeslots; and the first node is configured to transmit, during a first instance of the fifth timeslot, a second data packet of the set of data packets to the second node.

In any one or combination of the embodiments disclosed herein: a second relay node included among the relay nodes of the communications network is configured to transmit, during a second instance of the fifth timeslot, the first data packet toward the destination node; the second node is configured to transmit, during a third instance of the second timeslot, the second data packet to the first relay node; the first relay node is configured to transmit, during a third instance of the third timeslot, the second data packet toward the destination node; and a third relay node included among the relay nodes of the communications network is configured to transmit, during the third instance of the third timeslot, the first data packet toward the destination node.

In any one or combination of the embodiments disclosed herein, the reservation includes an indication of a quantity of instances of the third timeslot and a quantity of instances of the fifth timeslot for which the resources are to remain reallocated to the first node.

In any one or combination of the embodiments disclosed herein, the resources are reallocated to the one or more relay nodes, after the first node has completed transmitting the set of data packets to the second node.

In any one or combination of the embodiments disclosed herein, the first node is configured to transmit, during a second instance of the first timeslot, a final data packet of the set of data packets to the second node.

In any one or combination of the embodiments disclosed herein, a further relay node which is included among the relay nodes of the communications network and neighbors the destination node is configured to transmit the first data packet to the destination node, wherein: the transmitting of the first data packet by the first node to the second node is according to a first communications protocol; the transmitting of the first data packet by the second node to the first relay node is according to a second communications protocol different from the first communications protocol; and the transmitting of the first data packet by the further relay node to the destination node is according to the first communications protocol.

In any one or combination of the embodiments disclosed herein, the second node is configured to transmit, during the first instance of the second timeslot, an acknowledgement message to the first node with respect to the reservation.

In any one or combination of the embodiments disclosed herein: a relay node which is included among the relay nodes of the communications network and neighbors the destination node is configured to transmit a data packet of the set of data packets during a subsequent instance of the third timeslot or a subsequent instance of a fifth timeslot among the set of timeslots; and the destination node is configured to receive the data packet.

In any one or combination of the embodiments disclosed herein: the first node is configured to exchange data with the second node using a first communications protocol; the second node and the relay nodes are configured to exchange data with one another using a second communications protocol different from the first communications protocol; and a relay node included among the relay nodes is configured to exchange data with the destination node using the first communications protocol.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of Time-spreading multiple access (TSMA) scheduling among different entities in accordance with some approaches.

FIG. 2 illustrates example simulation results based on implementing TSMA scheduling in accordance with some approaches.

FIG. 3 through FIG. 7 illustrate a scenario overview and example aspects of a transmission scheme among nodes of a system using (T)raffic-aware (I)nter(L)eaved TSMA (TILTSMA) scheduling in accordance with one or more embodiments of the present disclosure.

FIG. 8 through FIG. 13 illustrate a scenario overview and example aspects of a transmission scheme among nodes of a system using TILTSMA scheduling in accordance with one or more embodiments of the present disclosure.

FIG. 14 through FIG. 26 illustrate the further propagation of data packets using TILTSMA, in accordance with one or more embodiments of the present disclosure.

FIG. 27 is a plot illustrating latency versus goodput using TILTSMA compared to other approaches.

FIG. 28 is a block diagram of a distributed computer system, in which various aspects and functions discussed herein may be practiced.

FIG. 29 illustrates an example flowchart of a method in accordance with one or more embodiments of the present disclosure.

FIG. 30 through FIG. 69 illustrate failure cases in some other approaches.

### DETAILED DESCRIPTION

A detailed description of one or more embodiments of the disclosed apparatus and method are presented herein by way of exemplification and not limitation with reference to the Figures.

Time-division multiple access (TDMA) scheduling may either be inefficient (e.g., role-based or round-robin). For cases of optimized TDMA scheduling, the optimized TDMA scheduling may be limited to a specific topology (e.g., manual slot assignment). Some approaches of TDMA scheduling may implement an algorithm which generates transmission schedules that are topology transparent and robust, fair in the sense that all nodes have the same number of transmission slots, traffic adaptive in the sense that heavily loaded nodes can successfully use more transmissions slots if their neighbors are less loaded (e.g., are relatively lightly loaded), and further, simple, fast, and easy to implement.

Time-spreading multiple access (TSMA) scheduling may assign proper robust schedules to each node in a network such that each node will be able to transmit without collisions to each of its neighbors at least once per frame. In some cases, the slot assignments can be based on upper bounds on the global parameters N and D, but not on a detailed network topology, which ensures schedule robustness. In some cases, whenever possible, the frame length L may be significantly smaller than the number of nodes, by allowing spatial reuse of the channel.

An example TSMA algorithm which may be implemented in association with generating transmission schedules in accordance with some approaches is described herein.

Let N be the maximum number of nodes in the network; let D be the maximum number of neighbors a node may have. The TSMA algorithm may include finding a prime number q that satisfies q^{(k+1)}≥N where k=(q−1)/D. The TSMA algorithm may include assigning each of the N nodes a unique vector of k+1 integers in GF(q). The TSMA algorithm may include calculating the transmission slots S(v) for each node v.

In an example, for i=0 to q−1, the calculation may include:

$$γ = {\sum }_{l = 0}^{k - 1} {a}_{l} {β}_{i}^{l} mod GF ( q )$$

where βᵢ is the i-th element of GF(q)

and

S(v)=S(v)U{iq+ind(γ)+1} where ind(γ) is the unique integer for which

$$γ = {β}_{i}^{l}$$

The corresponding assignments may have the following properties: The assignments are Proper Robust Schedules. The frame length L=q². Every node may have exactly q transmission opportunities per frame. The maximum distance between any two of a node's transmission opportunities may be 2q-1 slots.

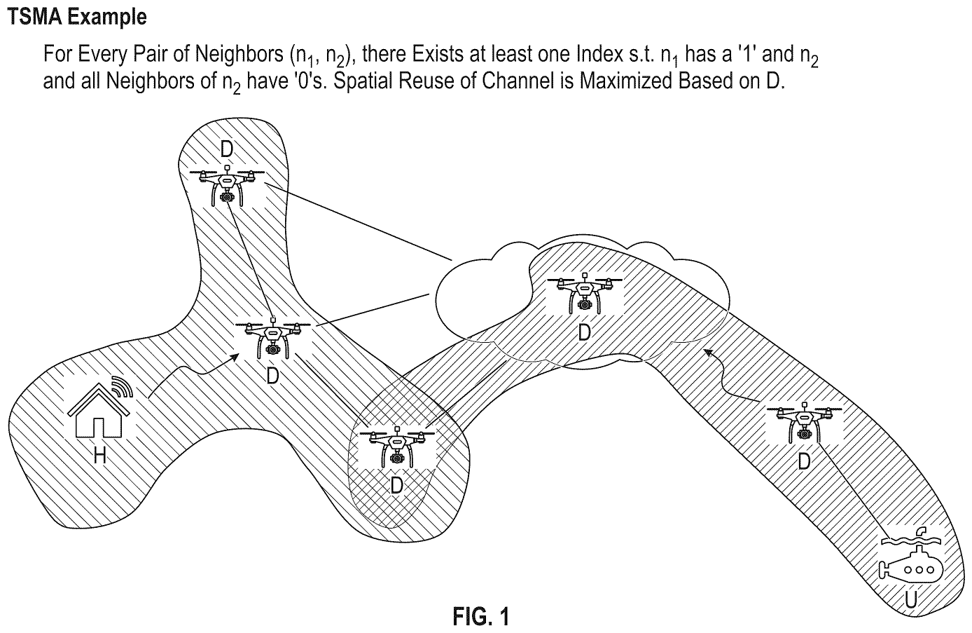

FIG. 1 illustrates an example of TSMA among different entities (e.g., H, D, U) in accordance with some approaches.

Example TSMA analytical results, theorems, and proofs supportive of TSMA in accordance with some approaches are described herein.

Theorem 1: The TSMA frame length

$$L = O ( \frac{{D}^{2} {log}^{2} N}{{log}^{2} D} )$$

Sketch of proof: By constructior

$$q \geq max \{ {N}^{\frac{1}{k + 1}} , kD + 1 \}$$

which implies q≥k₀D+1 where k₀ the solution to

$${N}^{\frac{1}{{k}_{0} + 1}} = {k}_{0} D + 1.$$

### Therefore

$$q = O ( \frac{D log N}{log D} ) ,$$

q may be of form p^{m}, where p is prime and m is an integer ≥1. For any n∈N, there is a prime between n and 2n, so

$$q \leq 2 ( {k}_{0} D + 1 ) = O ( \frac{D log N}{log D} ) .$$

The result may follow from L=q².

Theorem 2: TSMA may degrade to round-robin TDMA in a fully-connected network.

Sketch of proof: In a fully connected network D=N−1, so

$$L = O ( \frac{{N}^{2} {log}^{2} N}{{log}^{2} N} ) = O ( {N}^{2} ) ,$$

which implies q=O(N). Therefore, the TSMA frame may be q round-robin iterations with maximum node transmission delay of 2N-1 slots.

Theorem 3: For any N, TSMA may produce a frame length which is within O(log n) times that of the best possible of all Proper Robust Schedules.

Sketch of proof: Given a bounded D, TSMA may yield a frame length of at most L=O(log² N). Let Lₒₚₜ be frame length produced by some optimal PRS generating algorithm. Since any node may possibly be the neighbor of any other, any pair of nodes may have differing transmission slot assignments. The number of possible assignments may be ≥N, so 2∧(L_opt)≥N, which implies Lₒₚₜ≥log N. The result may follow from the fact that L/Lₒₚₜ=O(log² N/log N)=O (log N).

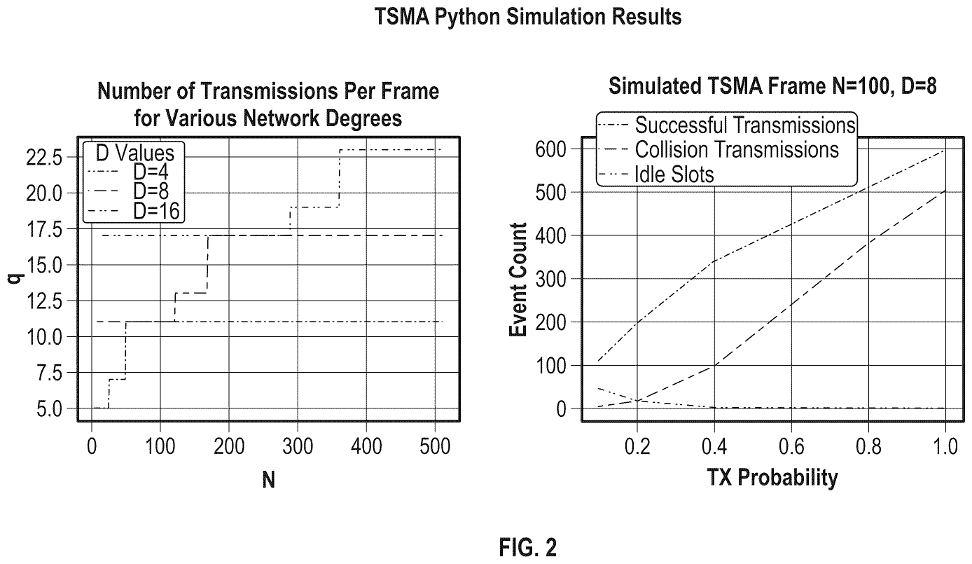

FIG. 2 illustrates example simulation results based on implementing TSMA in accordance with some approaches.

Application of TSMA may provide several technical advantages and improvements compared to other approaches.

Fewer Collisions: Through implementing TSMA, nodes may only collide with the subnet of neighbors that have access to a timeslot (compared to all neighbors as in the 2-slot approach).

Low delay: Implementing TSMA may, on average, dramatically reduce the queueing delay of all nodes compared to a round-robin TDMA. Sharing of the channel transmission delay may scale with D instead of N.

High reliability: Implementing TSMA may ensure that every pair of nodes can communicate at least once per frame. After q transmissions of a packet, the packet may be guaranteed to be received by all neighbors.

Fair: Through implementing TSMA, every node may have exactly q transmission opportunities per transmission frame. Heavily-loaded nodes may have more successful transmissions than lightly-loaded nodes (e.g., by using shared slots more often).

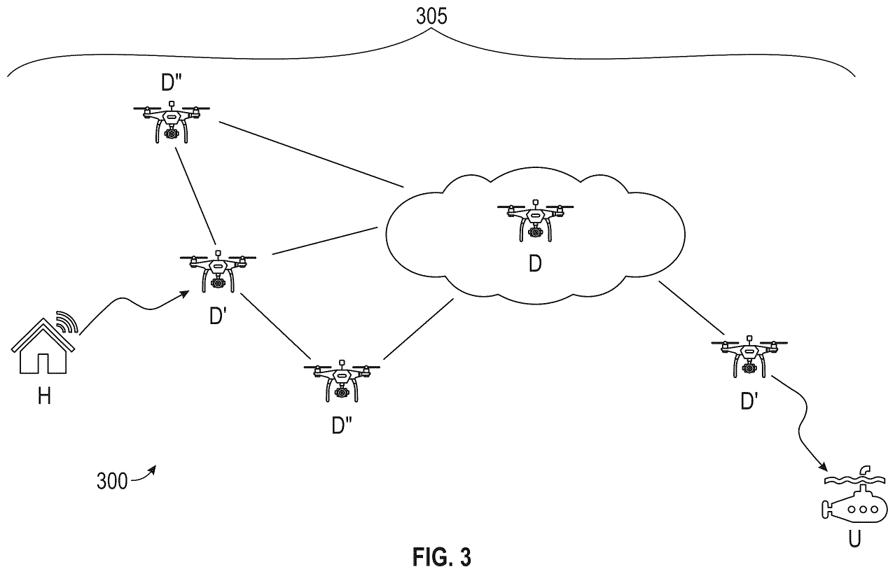

FIG. 3 through FIG. 7 illustrate a scenario overview and example aspects of a transmission scheme among nodes of a system 300 using (T)raffic-aware (I)nter (L)eaved TSMA (TILTSMA) in accordance with one or more embodiments of the present disclosure.

With reference to FIG. 3 through FIG. 7, the system 300 may include a node H (e.g., a home node, a source node), a node U (e.g., a receiver node), nodes D (e.g., relay nodes, for example, mobile relays, mobile underwater relays, or the like), and nodes G (gateway nodes). In a non-limiting example, node H may be an underwater node, and a node D′ may be a ground-to-space gateway for node H.

In some aspects, the nodes may be of distinct types (i.e. H, D, D′, D″, U) based on respective capabilities of the nodes. Each node may adhere to a respective ruleset for accessing a communications channel of a communications network 305 associated with the system 300, based on respective node type. In an example, D nodes, D′ nodes, and D″ nodes may be of the same device type (e.g., a drone, a type of relay device) but of different respective communications capabilities.

In some aspects, the system 300 may be referred to as a system of radios, with each radio being of a distinct type (i.e. H, D, D′, D″, U) based on respective capability set. For example, each of the nodes may include transceiver devices (e.g., transmitter devices, receiver devices) supportive of wireless communications with other nodes in the network.

In some cases, each of the nodes may be a stationary device or a mobile device capable of autonomous, semi-autonomous, or user-controlled navigation. Non-limiting examples of the nodes include vehicles, drone swarms, smart devices of a smart city network, autonomous vehicles supportive of autonomous driving platooning, and the like.

As will be described herein, implementing TILTSMA for wireless communications among nodes included in the system 300 may effectively address problems with some TSMA approaches. For example, in some cases, TSMA treats all nodes the same (e.g., as having the same constraints and traffic priorities). TILTSMA described herein may treat the nodes (e.g., H, D, D′, D″, U) included in the system 300 based on respective node class, with different constraints and traffic priorities respective to each node class.

Through TILTSMA described herein, U nodes may (1) transmit successfully with guarantee and (2) have minimal queuing delay (e.g., a queuing delay less than a delay threshold). Through the techniques described herein, an H node may successfully transmit large amounts of traffic to a gateway node D′ (e.g., with a collision amount satisfying a threshold value, with a goodput satisfying a threshold value), and nodes (e.g., gateway nodes D′, nodes D″, nodes D) between the H node and a target U node may (1) reliably relay data between the U node and the H node (e.g., with a collision amount satisfying a threshold value, with a goodput satisfying a threshold value).

As will be described herein, the TILTSMA scheduling may implement a communications algorithm that describes when a radio is allowed to access a shared channel medium. The TILTSMA scheduling described herein may include a combination of short-term reservations and TDMA-like channeling sharing, thereby ensuring a relatively low collision rate while retaining goodput.

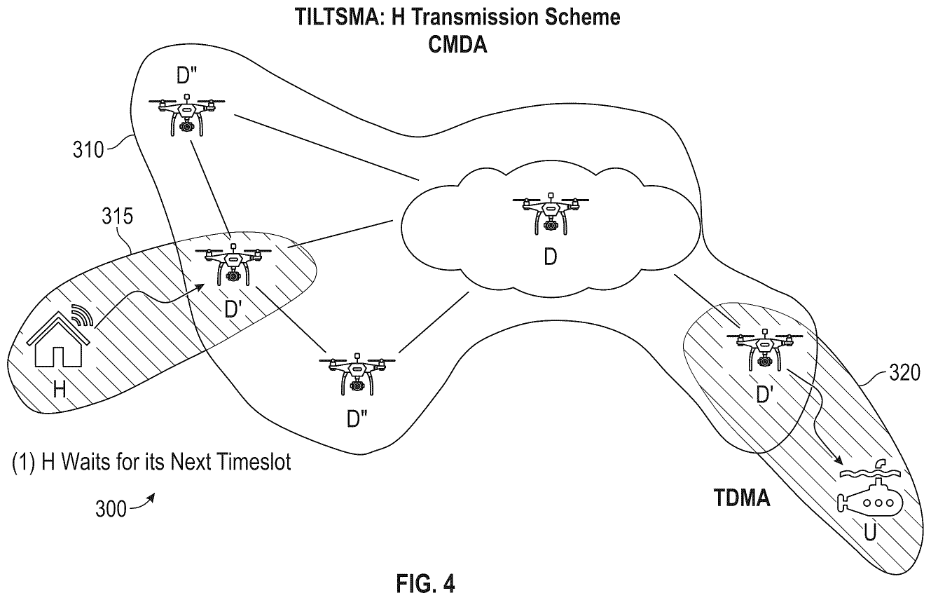

An example transmission scheme implemented by node H using TILTSMA is now described with reference to FIG. 4 through FIG. 7. In the example, nodes D, D′, and D″ are capable of communicating with one another via a communications network 310 (e.g., a code-division multiple access (CDMA) network), node H and node D′ are capable of communicating with one another via a communications network 315 (e.g., a TDMA network), and node U and node D′ are capable of communicating with one another via a communications network 320 (e.g., a TDMA network).

Accordingly, for example, the nodes D′ may serve as respective gateway nodes for connecting the node H and the node U to the communications network 310 (and to the nodes D′, the node D, and the nodes D″ included in the communications network 310).

CDMA and TDMA are example communications protocols associated with the communications network 310, the communications network 315, and the communications network 320, and embodiments of the present disclosure are not limited thereto. For example, the communications network 310 may support a first wireless communications protocol, the communications network 315 and the communications network 320 may support a second wireless communications protocol different from the first wireless communications protocol, and the nodes D′ may be capable of wireless communications using both the first wireless communications protocol and the second wireless communications protocol.

In the example of FIG. 4, each node in communications network 310 is assigned a unique code for communicating over the communications network 310, in accordance with CDMA communications protocol. In contrast, in accordance with a TDMA communications protocol, each node in communications network 315 is assigned a respective timeslot for communicating over a communications channel of the communications network 315, and each node in communications network 320 is assigned a respective timeslot for communicating over a communications channel of the communications network 320.

With reference to FIG. 4 through FIG. 7, an example time slotted reservation flow provided via a TILTSMA transmission scheme supported by the present disclosure is described.

Referring to FIG. 4, node H waits for the next instance of the timeslot assigned to node H (i.e., the timeslot allocated for transmissions by the node H).

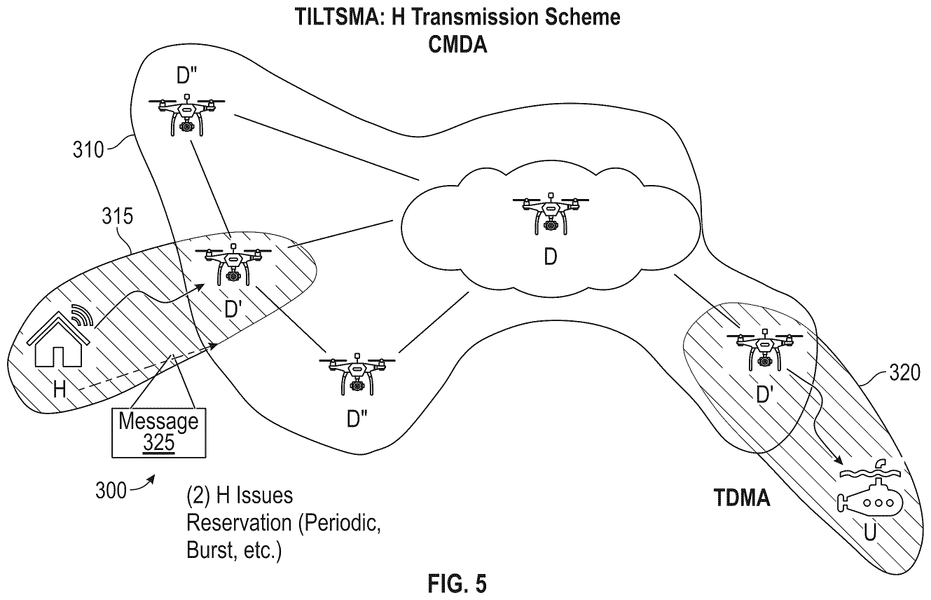

Referring to FIG. 5, during the next instance of the timeslot assigned to node H, node H issues a reservation for a transmission, transmitting a message 325 which includes or indicates details of the reservation. In some examples, the reservation may be for a periodic transmission (e.g., 20% of the channel over the next 3 minutes), a burst transmission (e.g., the next 10 timeslots, for example, for transmitting a relatively large amount of data), or other type of transmission. In some aspects, the reservation may include addresses associated with a target recipient node (e.g., node U). In some other aspects, the message 325 may be of a type that points to the reservation type desired by the node H.

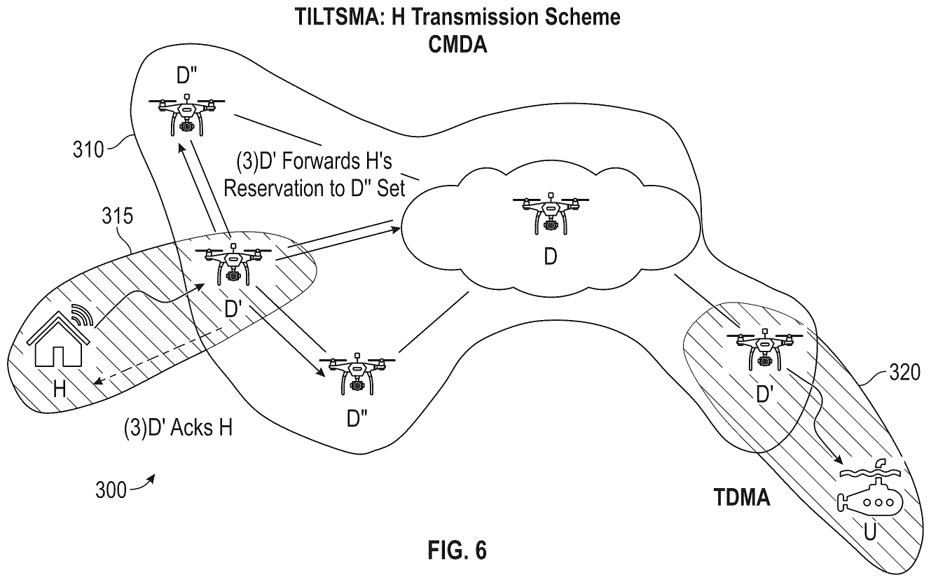

Referring to FIG. 6, during a timeslot assigned to node D′ for transmission, node D′ transmits an acknowledgement message to node H (i.e., node D′ acks node H) and forwards the reservation of node H. For example, in FIG. 6, node D′ forwards the reservation of node H to both nodes D″ and to node D. Accordingly, for example, node D′ is responsible for forwarding the reservation by node H to other nodes (e.g., nodes D″, node D).

In FIG. 6, nodes D″ are nodes whose respective transmissions would interfere with the transmission by node H if implemented at the same time (i.e., the same time slot) as node H, for example, due to relative distance from the node H and/or relative distance form node D′. In accordance with the techniques described herein, node D′ may forward the reservation to nodes D″ based on their respective distances to the node D′. For example, nodes D″ are neighboring nodes which are to relinquish their respective resources to node H based on the reservation.

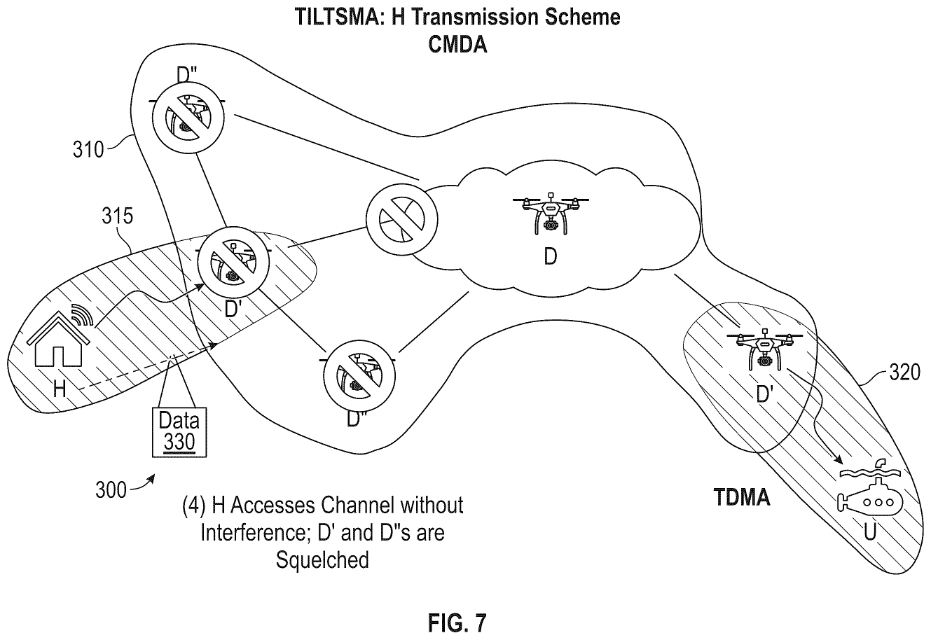

Referring to FIG. 7, node H accesses the channel without interference. Node H transmits data 330 to node D′. Transmissions by node D′, nodes D″, and node D which would otherwise interfere with transmissions by node H are prevented.

Accordingly, for example, the TILTSMA transmission protocol described herein enables node H to effectively barge in and be given priority for transmitting during timeslots initially reserved for transmissions by other nodes (e.g., nodes D″, node D″, node D′) in the communications network 310. The TILTSMA transmission protocol endows node H to effectively mute other nodes and prevent those nodes from transmitting during timeslots as requested by the node H.

Following receipt of the data 330 from node H, node D′ (serving as the gateway node for node H) may relay the data 330 to node D (e.g., directly, or indirectly via a node D″) using CDMA communications protocols. Node D may relay the data 330 to node D′ which is included in the communications network 320 and serving as a gateway node for node U, using CDMA communications protocols. Node D′ (serving as the gateway node for node U) may relay the data 330 to node U using TDMA communications protocols.

As has been illustrated herein, the TILTSMA transmission protocol may support effective transmissions and reduced interference, which may be beneficial for cases of high throughput transmissions and high priority transmissions by a source node (e.g., node H).

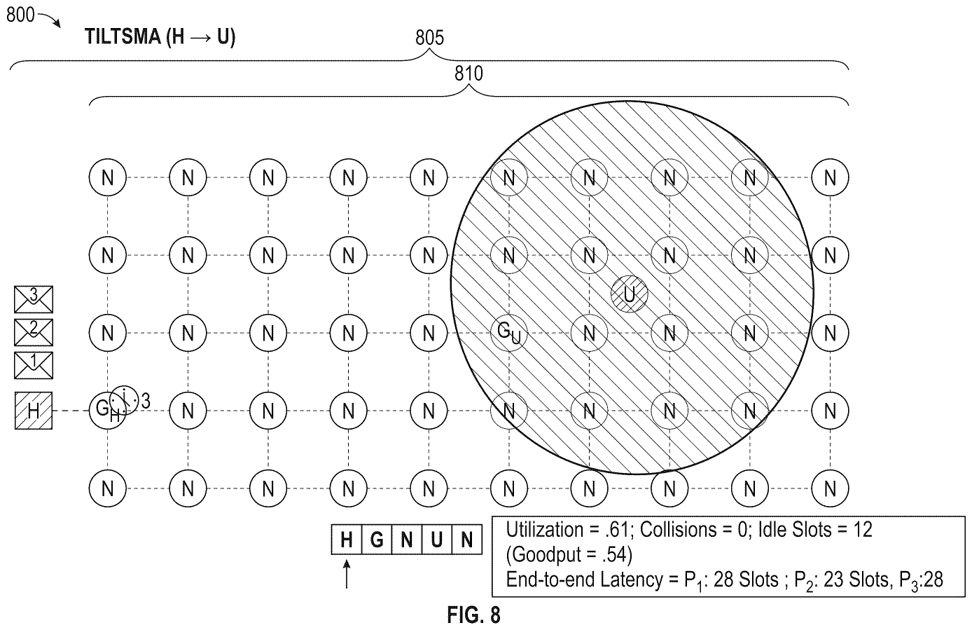

FIG. 8 to FIG. 13 illustrate another scenario overview and example aspects of a transmission scheme among nodes of a system 800 using TILTSMA scheduling in accordance with one or more embodiments of the present disclosure.

Node H and node U are examples of node H and node U described with reference to FIG. 3 through FIG. 7. Node GH is a gateway node for node H to a communications network 810 and is an example of node D′ which serves as a gateway node to node H in FIG. 3 through FIG. 7. Node Gu is a gateway node for node U to the communications network 810 and is an example of node D′ which serves as a gateway node to node U in FIG. 3 through FIG. 7. Each of the nodes N may be a node D, a node D′, or a node D″ which relays data as described with reference to FIG. 3 through FIG. 7.

In the example of the system 800, five timeslots H, G, N, U, N are allocated for the four different roles described herein: node H (i.e., a source node), node G (i.e., a gateway node), node N (i.e., a relay node), and node U (i.e., a recipient node, a destination node). In the example of the system 800, nodes N are general relay nodes for communicating data between node U and node H, node GH is a gate way node selected (from among nodes N) by node H, and node Gu is a gateway node selected (from among nodes N) by node U.

As illustrated with reference to FIG. 8 through FIG. 13, the time slotted reservation flow provided via a TILTSMA transmission protocol described herein may enable all packets (e.g., data packet 1 through data packet 3) to be transmitted from node H and successfully received by node GH in a single round of the timeslots H, G, N, U, N, even though a single timeslot H is initially allocated to node H for transmission. The described time slotted reservation flow may also be implemented by node U in a single round of the timeslots U, N, H, G, N, but detailed descriptions thereof are omitted for brevity.

Referring to FIG. 8, at timeslot H allocated to node H (e.g., a first instance of timeslot H), node H issues a reservation for a transmission. For example, node H may transmit a message (e.g., message 325 described with reference to FIG. 5) to node GH, and the message includes or indicates details of the reservation. In the example of FIG. 8, the reservation is for an additional three slots (i.e., slot N, slot U, and slot N).

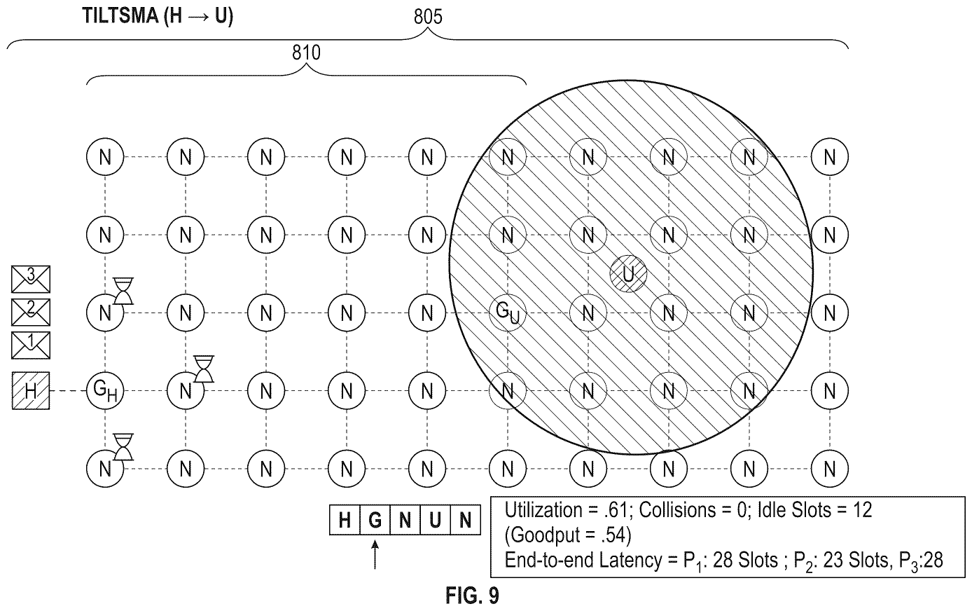

Referring to FIG. 9, at timeslot G allocated to node GH, during timeslot G assigned to node GH for transmission, node GH transmits an acknowledgement message to node H and forwards the reservation by node H to nodes N which are within a distance of one node from node GH and/or from node H.

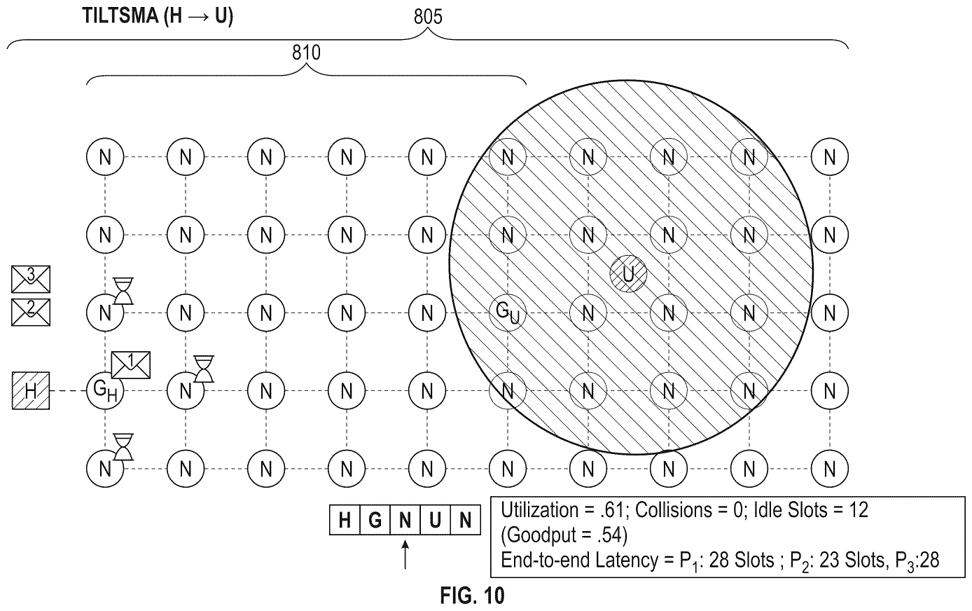

Referring to FIG. 10 through FIG. 13, at timeslot N, timeslot U, timeslot N, and the next instance of timeslot H (e.g., a second instance of timeslot H), node H may access the channel without interference.

For example, referring to FIG. 10, at slot N, node H transmits (and node GH receives) data packet 1.

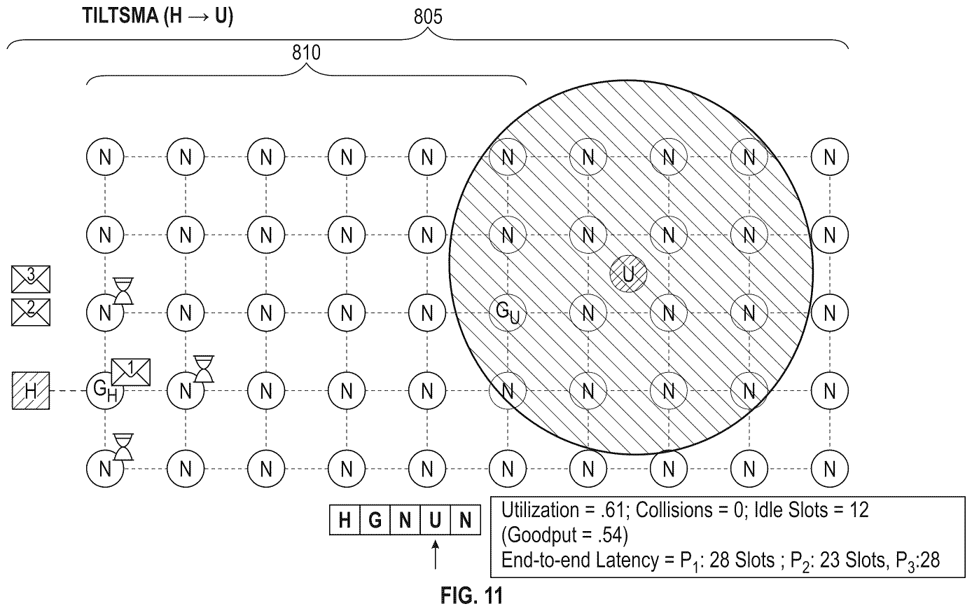

Referring to FIG. 11, at slot U, node U may remain in an idle state. Additionally, or alternatively, node U may similarly transmit a data packet (not illustrated) without interference from nodes N which are neighboring node U.

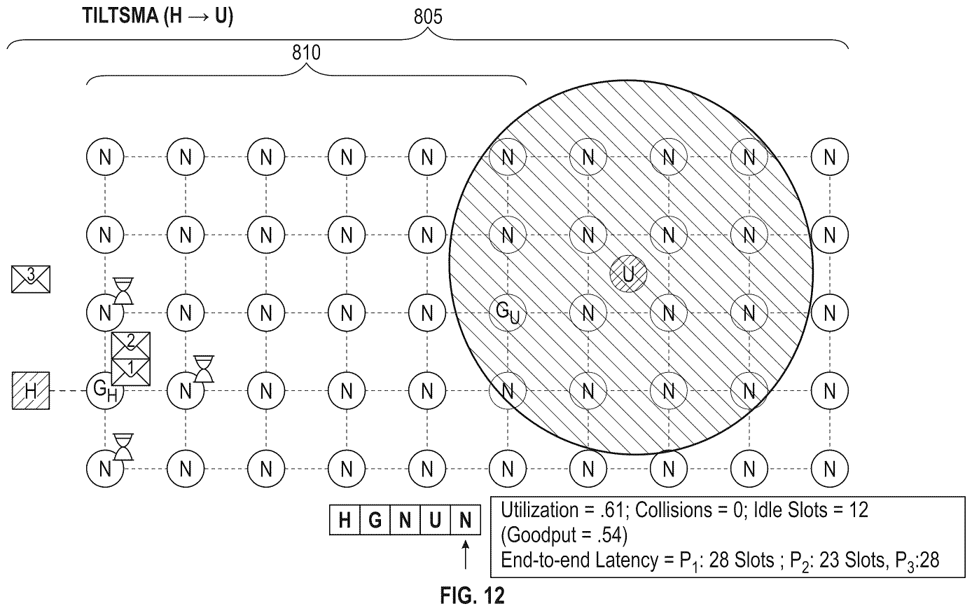

Referring to FIG. 12, at slot N, node H transmits (and node GH receives) data packet 2.

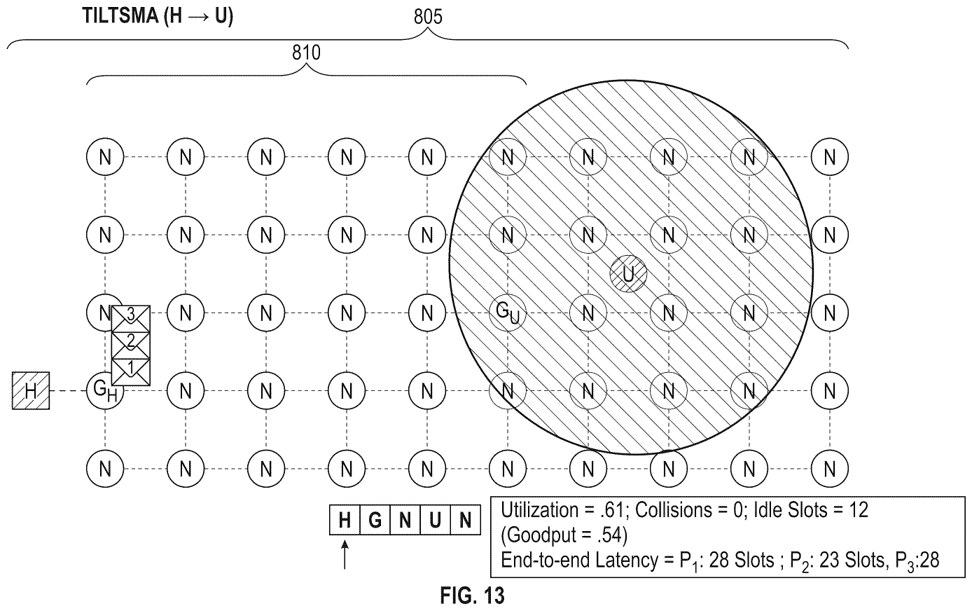

Referring to FIG. 13, at the next instance of timeslot H (e.g., second instance of timeslot H), node H transmits (and node GH receives) data packet 3.

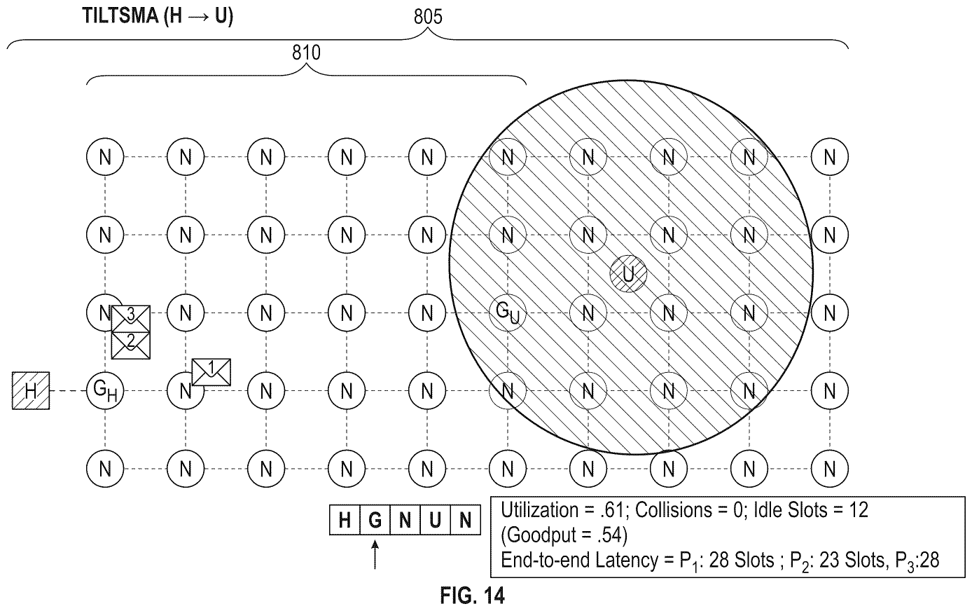

FIG. 14 through FIG. 27 illustrate the further propagation of data packet 1 through data packet 3 to node U via the nodes N of the communications network 810, in accordance with one or more embodiments of the present disclosure.

Referring to FIG. 14, at timeslot G, node GH transmits data packet 1 to a node N.

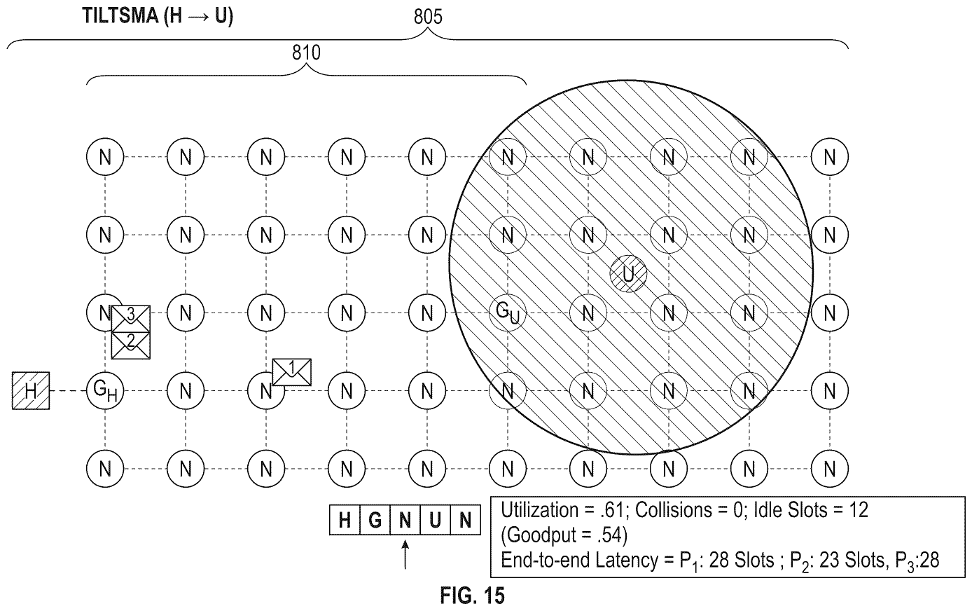

Referring to FIG. 15, at timeslot N, the node N further transmits the data packet 1 to a next node N.

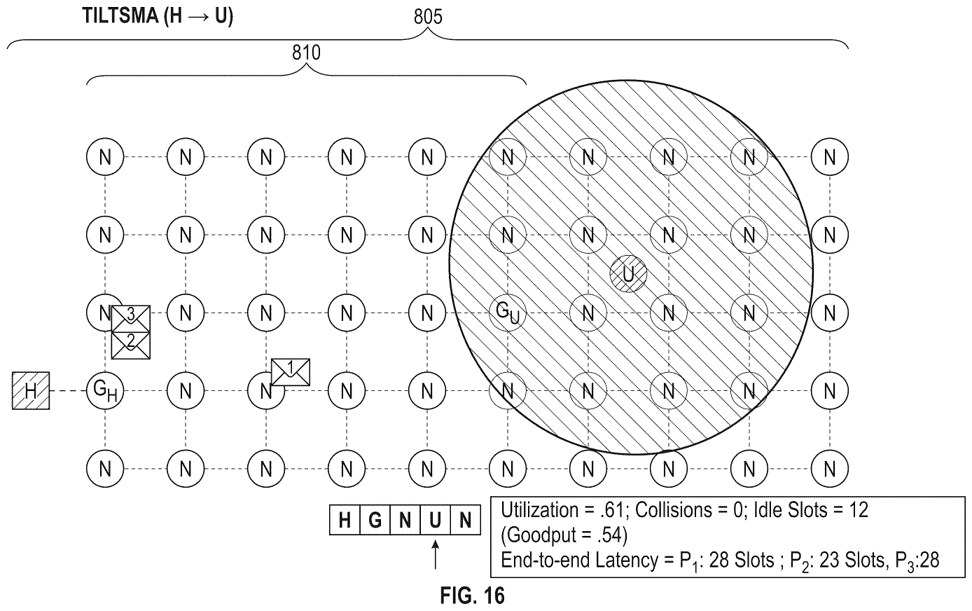

Referring to FIG. 16, at timeslot U, node U may remain in an idle state.

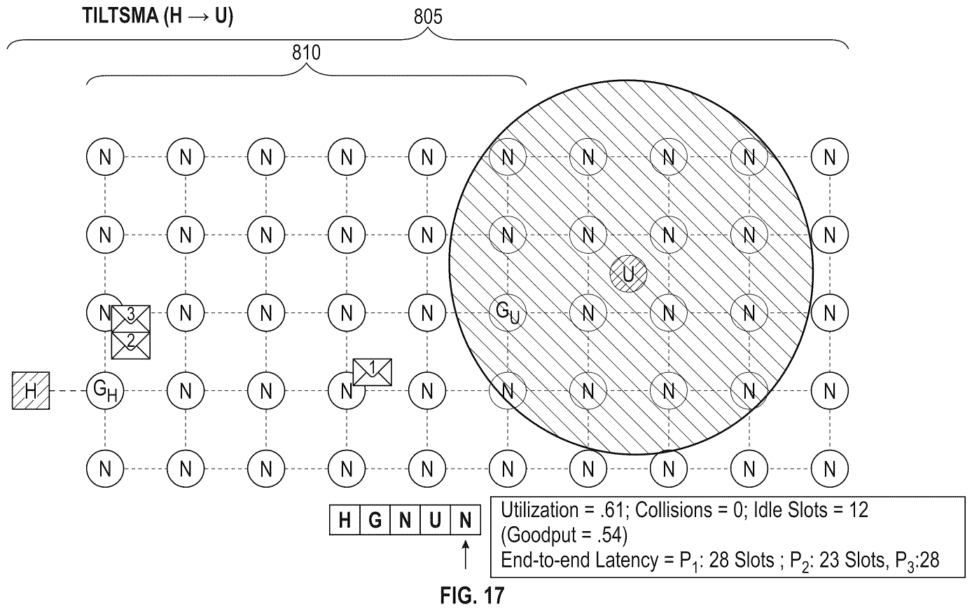

Referring to FIG. 17, at timeslot N, the node N further transmits the data packet 1 to a next node N.

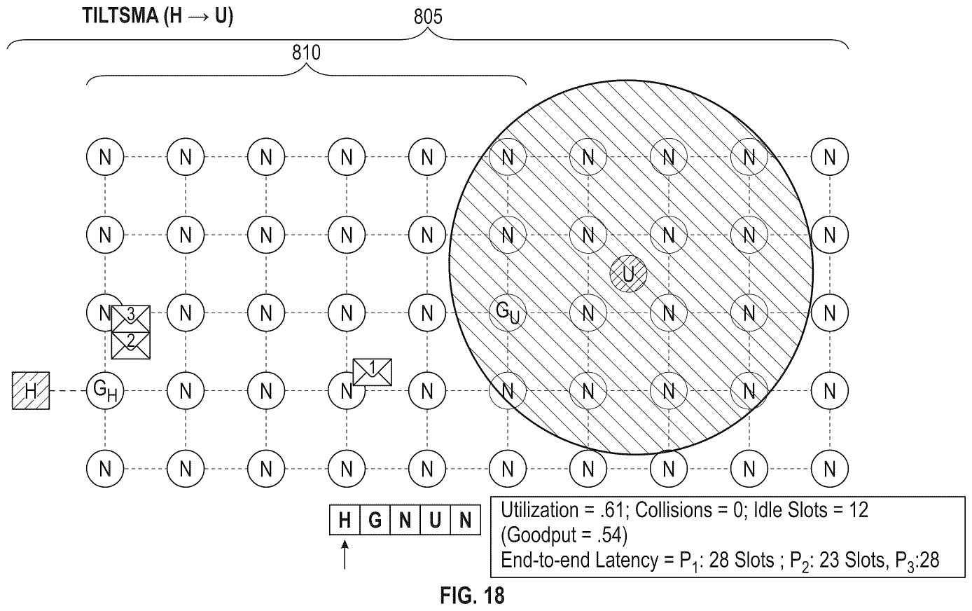

Referring to FIG. 18, at timeslot H, node H may maintain an idle state and may refrain from transmitting further data packets.

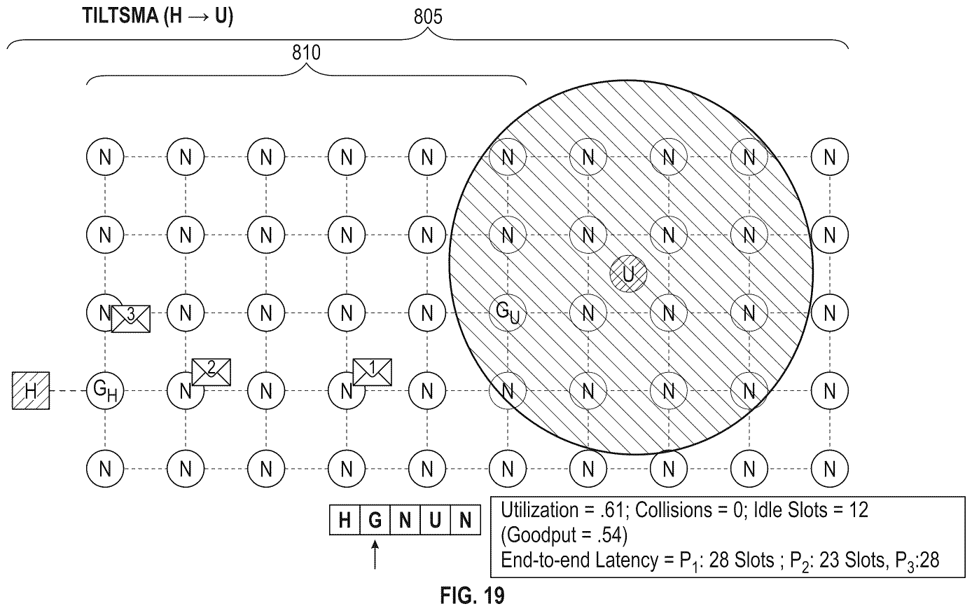

Referring to FIG. 19, at timeslot G, node GH transmits data packet 2 to a node N.

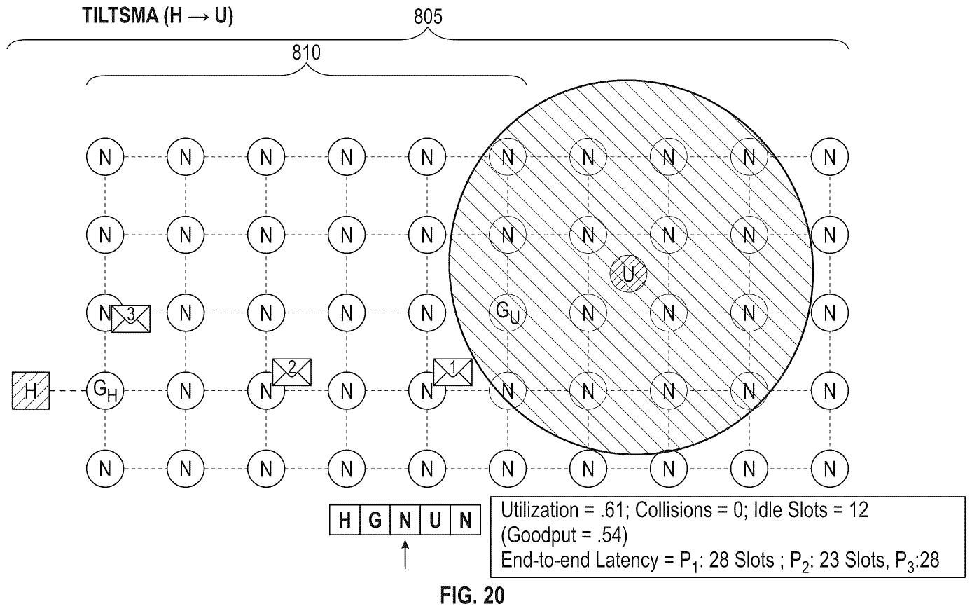

Referring to FIG. 20, at timeslot N, the nodes N respectively further transmit the data packet 1 and the data packet 2 to a next node N.

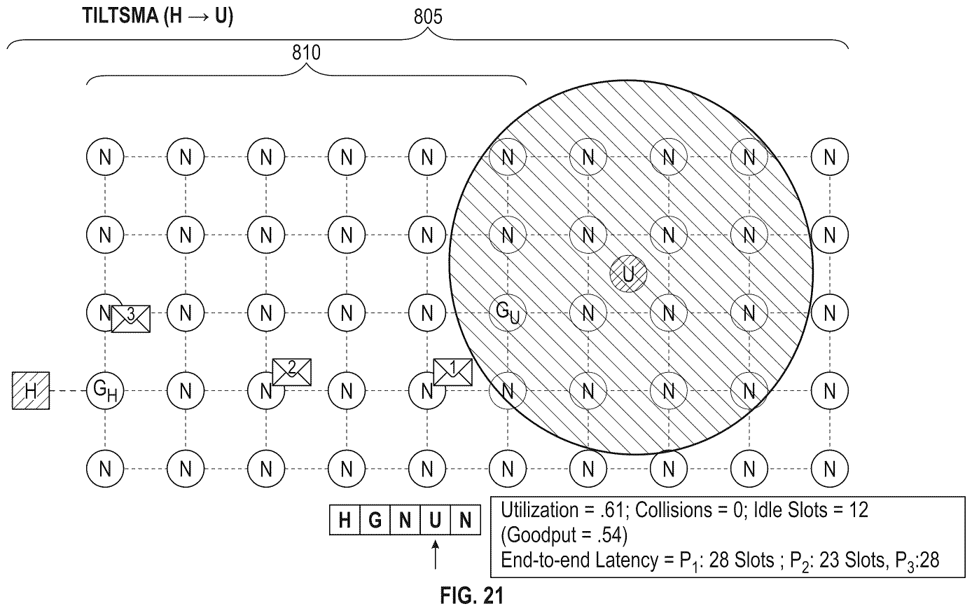

Referring to FIG. 21, at timeslot U, node U may remain in an idle state.

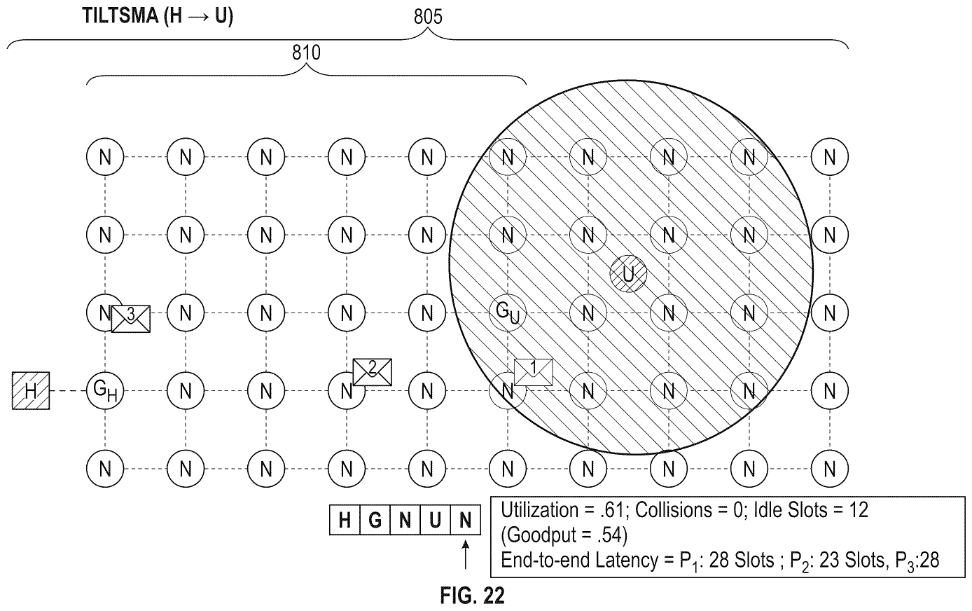

Referring to FIG. 22, at timeslot N, the nodes N respectively further transmit the data packet 1 and the data packet 2 to a next node N.

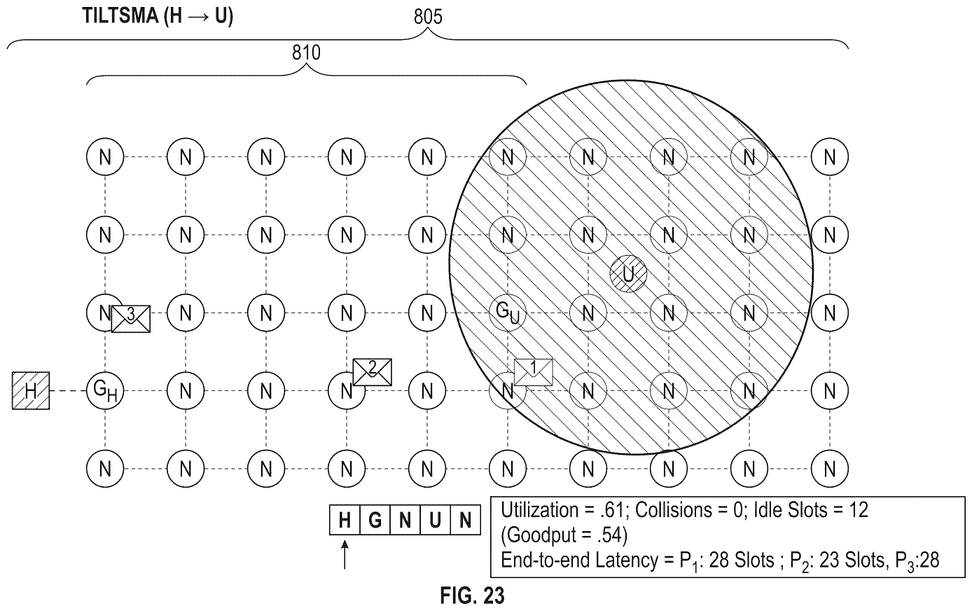

Referring to FIG. 23, at timeslot H, node H may maintain an idle state and may refrain from transmitting further data packets.

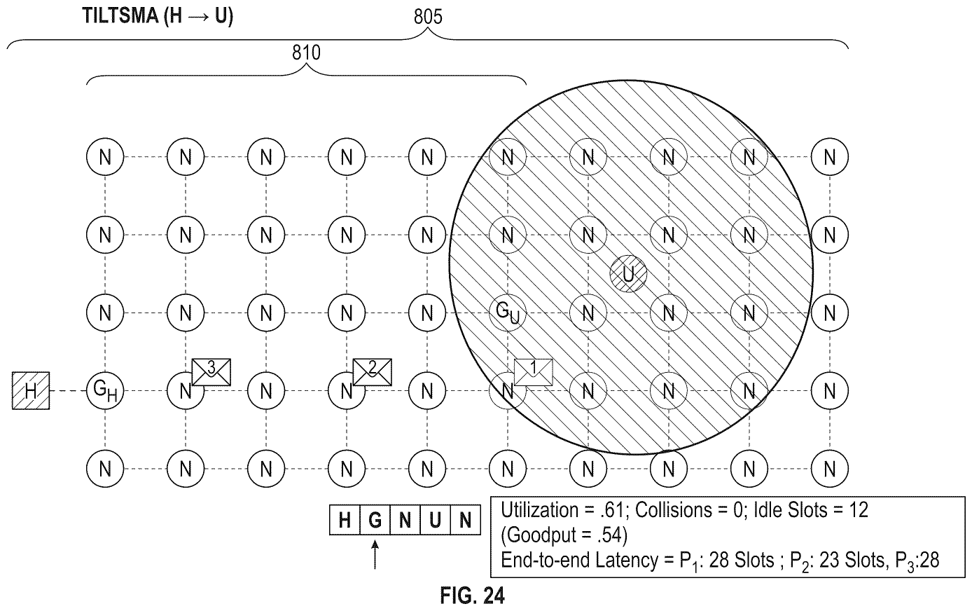

Referring to FIG. 24, at timeslot G, node GH transmits data packet 3 to a node N.

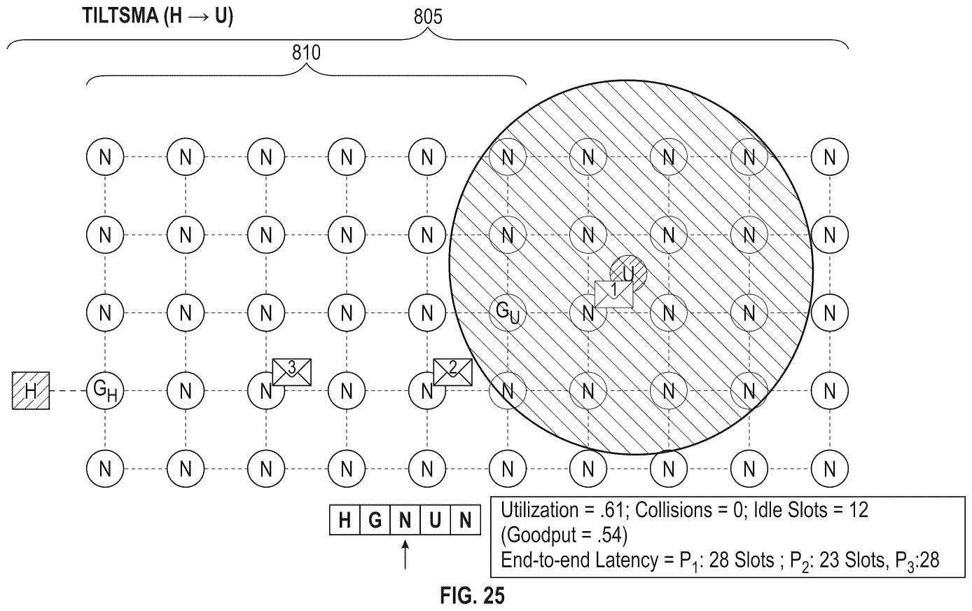

Referring to FIG. 25, the nodes N respectively further transmit the data packet 1, the data packet 2, and the data packet 3 to a next node N. In FIG. 25, the node N which was in possession of the data packet 1 (as previously illustrated at FIG. 24) transmits the data packet 1 to a node N which neighbors the node U.

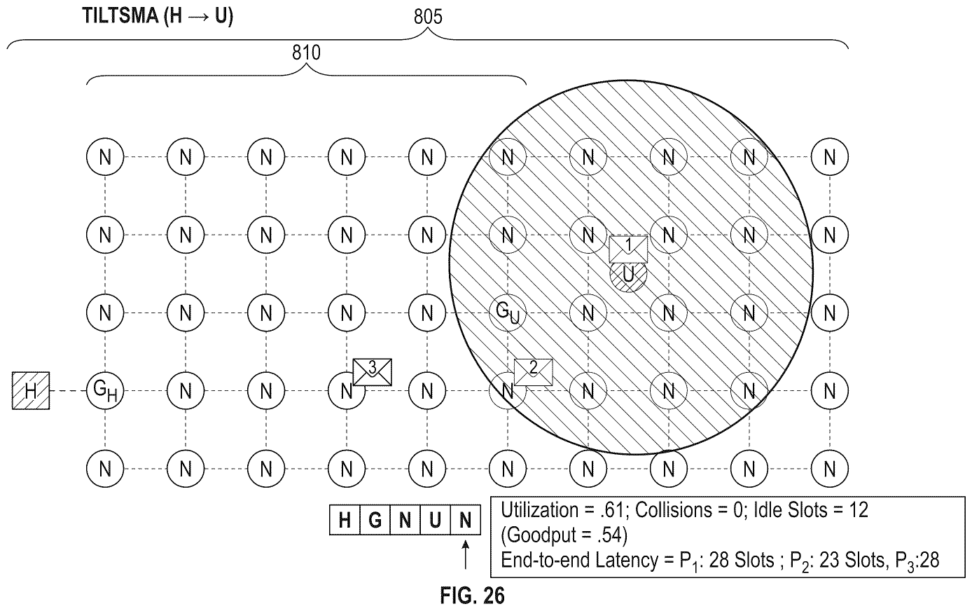

Referring to FIG. 26, the nodes N respectively further transmit the data packet 2 and the data packet 3 to a next node N.

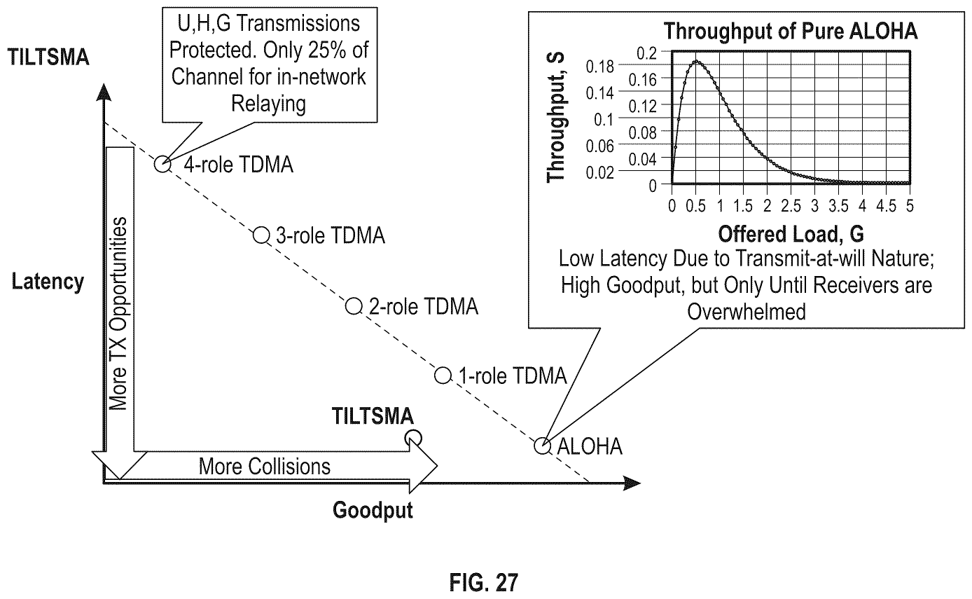

Referring to FIG. 27, the node N which neighbors the node U and is in possession of the data packet 1 (as previously illustrated at FIG. 25) transmits the data packet 1 to the node U. The described process may continue (not illustrated) using the techniques described herein until the data packet 2 and the data packet 3 are transmitted to and received by the node U.

As has been described herein, the TILTSMA transmission protocol and scheduling supported by the present disclosure provides time slotting which prevents the loss of packets due to simultaneous transmissions. The TILTSMA transmission protocol maintains a gap between nodes through packet pacing, such that nodes which are simultaneously transmitting do not interfere with (i.e., hear) one another. The TILTSMA transmission protocol as illustrated herein avoids unnecessary waste of bandwidth.

In the example approaches described herein, TILTSMA may include assigning fixed timeslots to a node U, which may ensure successfully TX and upper-bounds delay. TILTSMA may provide a node H with priority access to the channel based on bandwidth reservation among nodes N which neighbor the node H. Through packet pacing, TILTSMA may ensure packets are successfully received at an intended node U, by preventing simultaneous transmissions by nodes N from interfering with one another. For example, with reference back to FIG. 19 through FIG. 27, the nodes N which transmit the data packets 1 through 3 are spaced apart by a distance of two nodes N. TILTSMA includes prioritizing packet transmission by a U node over status messages for the U node or status messages of the network 305, which may ensure prioritized delivery of packets from node U to node H (i.e., node U→node H).

According to the TILTSMA scheduling described herein, relaying decisions are made intelligently, exploiting inter-nodal coordination rather than granular role-based slots. The TILTSMA scheduling may be implemented with an assumption of globally time slotted radios (i.e., no carrier sensing). The techniques described herein overcome other approaches which focus on the fate of specific packets, rather than considering streams of application data. The techniques described herein overcome other approaches which erroneously rely on simultaneous receiving capability (i.e., a simultaneous receive condition) for ensuring packet safety.

The TILTSMA scheduling described herein may be applied to solving problems related to the domain of acoustic networks, using inter-nodal communication instead of spectrum sharing.

The TILTSMA scheduling described herein may be applied to communication between undersea sensors. In some embodiments, transmitters implemented at the nodes (e.g., node H, node GH, nodes N, node U) of a system may be acoustic transmitters rather than optical transmitters, and the TILTSMA scheduling may be implemented without having a local knowledge of the network topology. The techniques described herein may support effective undersea monitoring and communication.

FIG. 27 is a plot 2700 illustrating latency versus goodput using TILTSMA described herein, compared to other approaches of 4-role TDMA, 3-role TDMA, 2-role TDMA, 1-role TDMA, and ALOHA (a random access method for sharing wireless channels). TILTSMA in accordance with one or more embodiments of the present disclosure attains reduced latency and comparable goodput. Goodput may refer to application-level throughput of a communication, e.g., the number of useful information bits delivered from a source (e.g., a source node, a network) to a destination per unit of time.

The TILTSMA scheduling in accordance with one or more embodiments of the present disclosure solves the problem of collisions between undersea low throughput relays in shared TDMA networks. The TILTSMA scheduling in accordance with one or more embodiments of the present disclosure solves the problem of high delay in collision-free TDMA schedules.

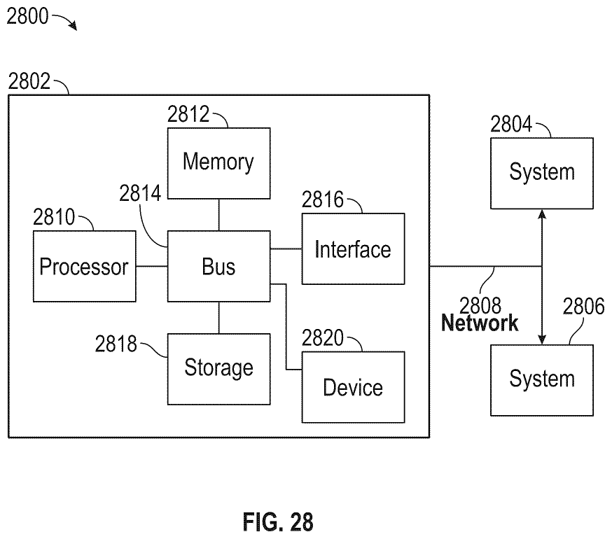

FIG. 28 is a block diagram of a distributed computer system 2800, in which various aspects and functions discussed herein may be practiced. The distributed computer system 2800 may include one or more computer systems. For example, as illustrated, the distributed computer system 2800 includes three computer systems 2802, 2804 and 2806. As shown, the computer systems 2802, 2804 and 2806 are interconnected by, and may exchange data through, a communication network 2808.

The network 2808 may include any communication network through which computer systems may exchange data. To exchange data via the network 2808, the computer systems 2802, 2804, and 2806 and the network 2808 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA IIOP, RMI, DCOM and Web Services.

The computer systems 2802, 2804, and 2806 and the network 2808 may include any computing devices comprising substantially similar capabilities, descriptions, functions, and configurations as described herein. Devices connected via a network may also be referred to as nodes.

The network 2808 may comprise the any network or number of networks including the Internet, local area networks, metropolitan area networks, and wide area networks. The network 2808 may comprise computing devices connected via cables, IR ports, wireless signals, or any other means of connecting multiple computing devices.

The network 2808 may comprise mobile telephone networks utilizing any protocol or protocols used to communicate among mobile devices, including AMPS, TDMA, CDMA, GSM, GPRS or UMTS. The network 2808 may comprise a number of physically distinct networks, or the network 2808 may comprise a unified network. The network 2808 may have any network topology, and any devices or networks within the network 2808 may be connected in any manner.

An embodiment of a node (e.g., node H, node D, node D′, node D″, node N, node GH, node U) described herein includes devices and/or systems for communicating with other nodes and may be implemented by a computing device (e.g., any of computer systems 2802, 2804, and 2806) described herein. For example, each node may include a communication system having a suitable device 2820 including an antenna or other transmitter/receiver for communicating with the network 2808, generating and transmitting signals for communicating over the network 2808, receiving and decoding signals received over the network 2808, and the like.

In an example, the device 2820 may include one or more transceiver devices supportive of communications using one or more communications protocols (e.g., LTE, 4G, 5G, Wifi, Bluetooth, TDMA, CDMA, FDMA, TILTSMA scheduling described herein, or the like). Embodiments of the present disclosure are not limited thereto, and the device 2820 may include other transceiver devices supportive of communications using protocols other than the example protocols described herein.

According to some embodiments, the functions and operations discussed herein with respect to TILTSMA can be executed on computer systems 2802, 2804 and 2806 individually and/or in combination. For example, the computer systems 2802, 2804, and 2806 support, for example, participation in a collaborative network. In one alternative, a single computer system (e.g., 2802) can perform the communication operations described herein with respect to TILTSMA. The computer systems 2802, 2804 and 2806 may include personal computing devices such as cellular telephones, smart phones, tablets, “fablets,” etc., and may also include desktop computers, laptop computers, etc.

Various aspects and functions in accordance with embodiments discussed herein may be implemented as specialized hardware or software executing in one or more computer systems including the computer system 2802 shown in FIG. 28. In one embodiment, computer system 2802 is a personal computing device specially configured to execute the processes and/or operations discussed herein. As depicted, the computer system 2802 includes at least one processor 2810 (e.g., a single core or a multi-core processor), a memory 2812, a bus 2814, input/output interfaces (e.g., 2816) and storage 2818. The processor 2810, which may include one or more microprocessors or other types of controllers, can perform a series of instructions that manipulate data. As shown, the processor 2810 is connected to other system components, including a memory 2812, by an interconnection element (e.g., the bus 2814).

The memory 2812 and/or storage 2818 may be used for storing programs and data during operation of the computer system 2802. For example, the memory 2812 may be a relatively high performance, volatile, random access memory such as a dynamic random access memory (DRAM) or static memory (SRAM). In addition, the memory 2812 may include any device for storing data, such as a disk drive or other non-volatile storage device, such as flash memory, solid state, or phase-change memory (PCM). In further embodiments, the functions and operations discussed with respect to communications using the TILTSMA scheduling can be embodied in an application that is executed on the computer system 2802 from the memory 2812 and/or the storage 2818. For example, the application can be made available through an “app store” for download and/or purchase. Once installed or made available for execution, computer system 2802 can be specially configured to execute the functions associated with communications using the TILTSMA scheduling described herein.

Computer system 2802 also includes one or more interfaces 2816 such as input devices (e.g., camera for capturing images), output devices and combination input/output devices. The interfaces 2816 may receive input, provide output, or both. The storage 2818 may include a computer-readable and computer-writeable nonvolatile storage medium in which instructions are stored that define a program to be executed by the processor. The storage 2818 (storage system) also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 2802 may include an operating system that manages at least a portion of the hardware components (e.g., input/output devices, touch screens, cameras, etc.) included in computer system 2802. One or more processors or controllers, such as processor 2810, may execute an operating system which may be, among others, a Windows-based operating system (e.g., Windows NT, ME, XP, Vista, 7, 27, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present disclosure may be implemented as programmed or non-programmed components, or any combination thereof. Various embodiments may be implemented in part as MATLAB functions, scripts, and/or batch jobs. Thus, the disclosure is not limited to a specific programming language and any suitable programming language could also be used.

Although the computer system 2802 is shown by way of example as one type of computer system upon which various functions for communications using the TILTSMA scheduling may be practiced, aspects and embodiments are not limited to being implemented on the computer system, shown in FIG. 28. Various aspects and functions may be practiced on one or more computers or similar devices having different architectures or components than that shown in FIG. 28.

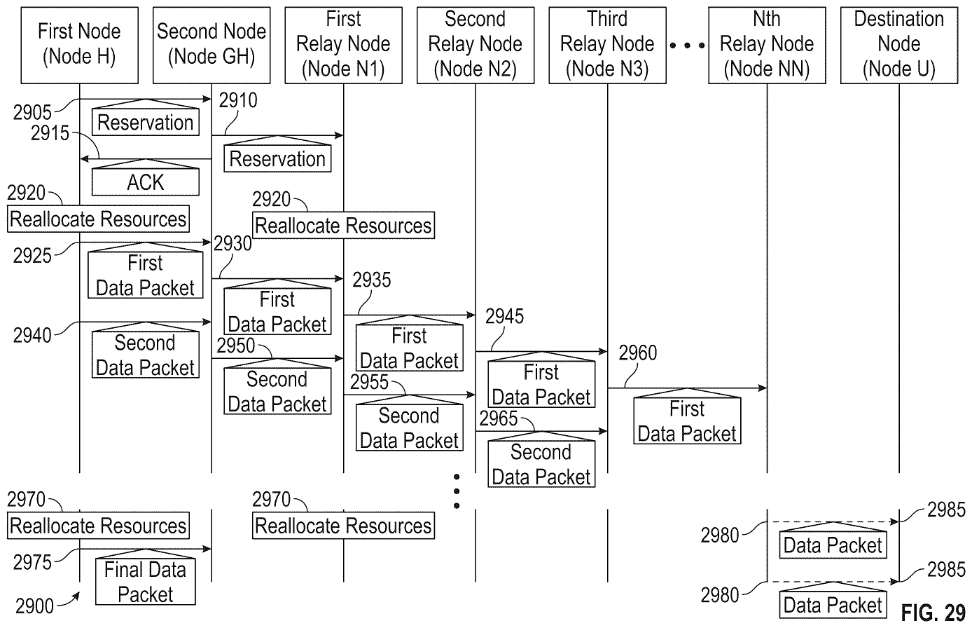

FIG. 29 illustrates an example flowchart of a method 2900 of transmitting data to a destination node over a communications network, in accordance with one or more embodiments of the present disclosure. The method 2900 may be implemented by the example aspects of a device or system as described herein.

Descriptions herein of a first node, a second node, and a destination node may be examples of a node H, a node GH (or node D′), and a node U, respectively, described with reference to FIGS. 3 through 26. Descriptions herein of a relay node may be examples of a node N, a node D″, or a node D described with reference to FIGS. 3 through 26.

At block 2905, the method 2900 may include transmitting, by a first node (e.g., node H) during a first instance of a first timeslot allocated to the first node from among a set of timeslots, a reservation associated with transmitting a set of data packets to the destination node.

At block 2910, the method 2900 may include transmitting, by a second node (e.g., node GH) during a first instance of a second timeslot allocated to the second node from among the set of timeslots, the reservation to one or more relay nodes which are within a threshold distance of the second node from among relay nodes of the communications network. In some aspects, one or more relay nodes to which the second node transmits the reservation may be neighboring the second node.

At block 2915, the method 2900 may include including transmitting, by the second node during the first instance of the second timeslot, an acknowledgement message (i.e., ACK) to the first node with respect to the reservation.

At block 2920, the method 2900 may include temporarily reallocating resources from the one or more relay nodes to the first node based on the reservation.

In some aspects, the resources are associated with a third timeslot among the set of timeslots and a fifth timeslot among the set of timeslots.

In some aspects, based on the reservation, the one or more relay nodes temporarily relinquish the resources allocated to the one or more relay nodes with respect to the third timeslot and the fifth timeslot.

In some aspects, the reservation includes an indication of a quantity of instances of the third timeslot and a quantity of instances of the fifth timeslot for which the resources are to remain reallocated to the first node.

At block 2925, the method 2900 may include transmitting, by the first node during a first instance of the third timeslot, a first data packet of the set of data packets to the second node.

At block 2930, the method 2900 may include transmitting, by the second node during a second instance of the second timeslot, the first data packet to a first relay node included among the relay nodes of the communications network. In some aspects, the first relay node is included among the one or more relay nodes which received the reservation.

At block 2935, the method 2900 may include transmitting, by the first relay node during a second instance of the third timeslot, the first data packet toward the destination node.

At block 2940, the method 2900 may include transmitting, by the first node during a first instance of the fifth timeslot, a second data packet of the set of data packets to the second node.

At block 2945, the method 2900 may include transmitting, by a second relay node included among the relay nodes of the communications network during a second instance of the fifth timeslot, the first data packet toward the destination node.

At block 2950, the method 2900 may include transmitting, by the second node during a third instance of the second timeslot, the second data packet to the first relay node.

At block 2955, the method 2900 may include transmitting, by the first relay node during a third instance of the third timeslot, the second data packet toward the destination node.

At block 2960, the method 2900 may include transmitting, by a third relay node included among the relay nodes of the communications network during the third instance of the third timeslot, the first data packet toward the destination node.

In some aspects, during the third instance of the third timeslot, the method 2900 may include refraining from transmitting any data packets from the second node and the second relay node.

At block 2965, the method 2900 may include transmitting, by the second relay node during a third instance of the fifth timeslot, the second data packet toward the destination node.

At block 2970, the method 2900 may include reallocating the resources to the one or more relay nodes, after the first node has completed transmitting the set of data packets to the second node.

In some aspects, the timing of the reallocation may be specified in the reservation, and the timing may include a quantity of instances of the third timeslot and a quantity of instances of the fifth timeslot after which the resources are to be reallocated back to the one or more relay nodes.

At block 2975, the method 2900 may include transmitting, by the first node during a second instance of the first timeslot, a final data packet (e.g., a third data packet, but not limited thereto) of the set of data packets to the second node.

At block 2980, the method 2900 may include transmitting, by relay node which is included among the relay nodes of the communications network and neighbors the destination node, a data packet of the set of data packets during a subsequent instance of the third timeslot or a subsequent instance of the fifth timeslot.

In an example, the data packet may be the first data packet, the second data packet, a data packet subsequent to the second data packet, or a final data packet of the set of data packets.

In an example, at block 2980, the method 2900 may include transmitting the first data packet by the further relay node included among the relay nodes of the communications network to the destination node. In some cases, the further relay node may transmit the first data packet to the destination node before the first node (i.e., node H) transmits the final data packet (i.e., based on the quantity of relay nodes between the second node (node GH)). In some other cases, the further relay node may transmit the first data packet to the destination node after the first node (i.e., node H) transmits the final data packet (i.e., based on a relatively larger quantity of relay nodes between the second node (node GH)).

In some aspects, the transmitting of the first data packet by the first node to the second node is according to a first communications protocol; the transmitting of the first data packet by the second node to the first relay node is according to a second communications protocol different from the first communications protocol; and the transmitting of the first data packet by the further relay node to the destination node is according to the first communications protocol.

At block 2995, the method 2900 may include receiving, by the destination node, the data packet.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

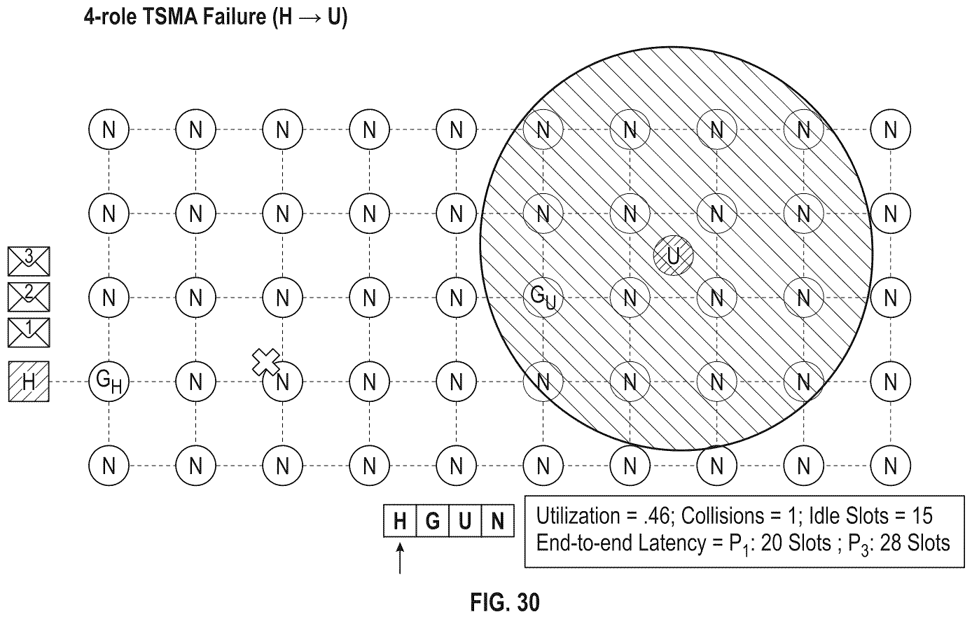

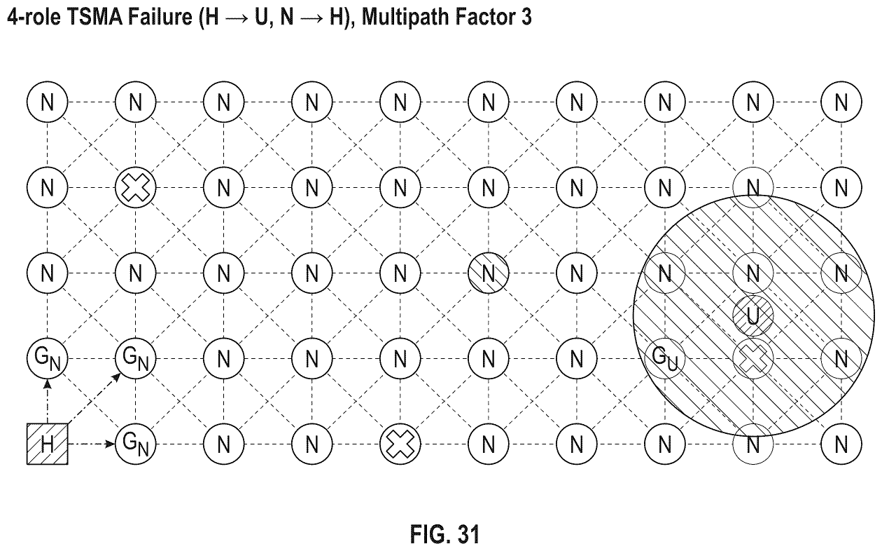

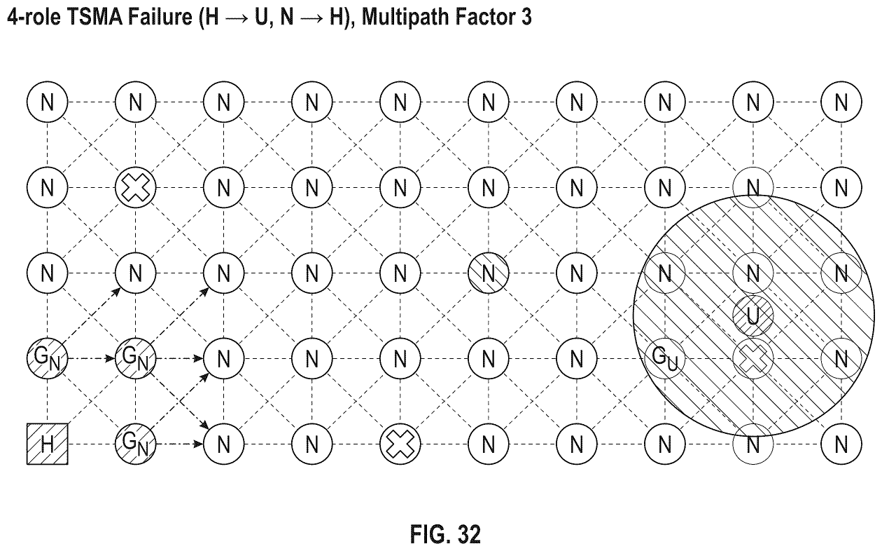

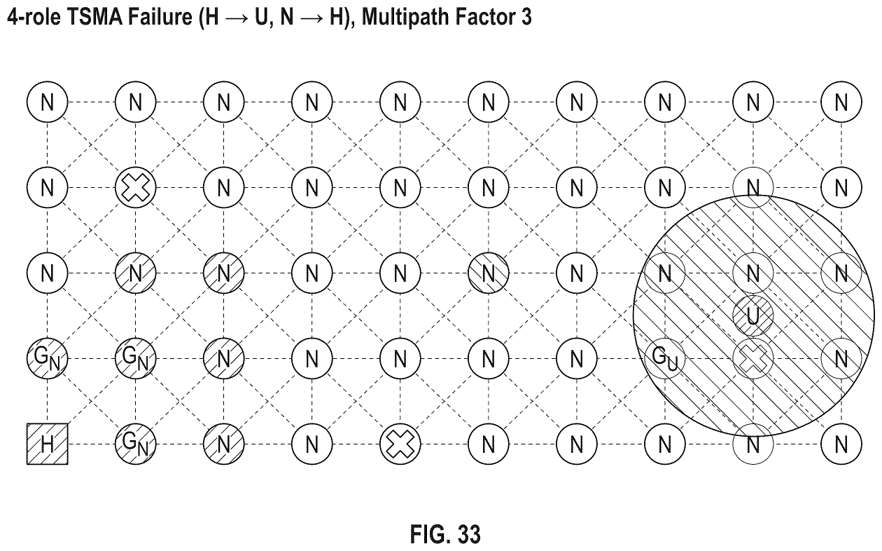

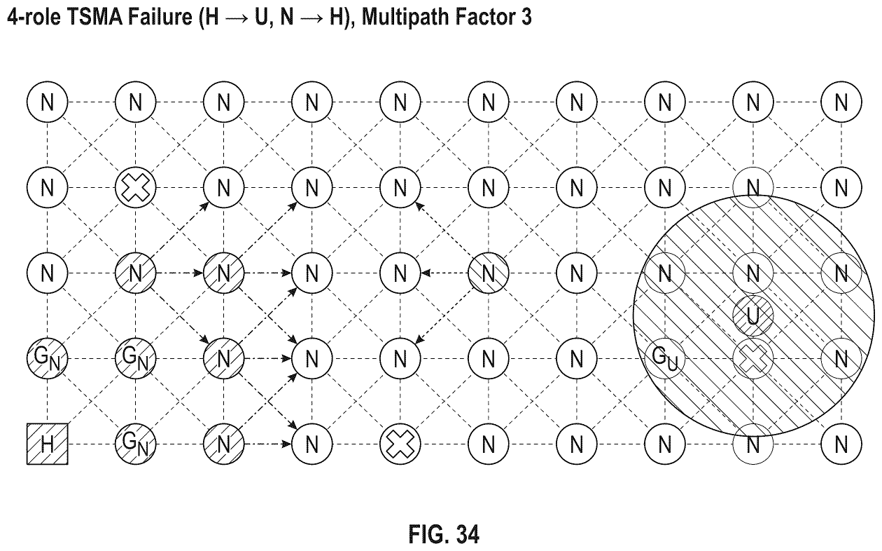

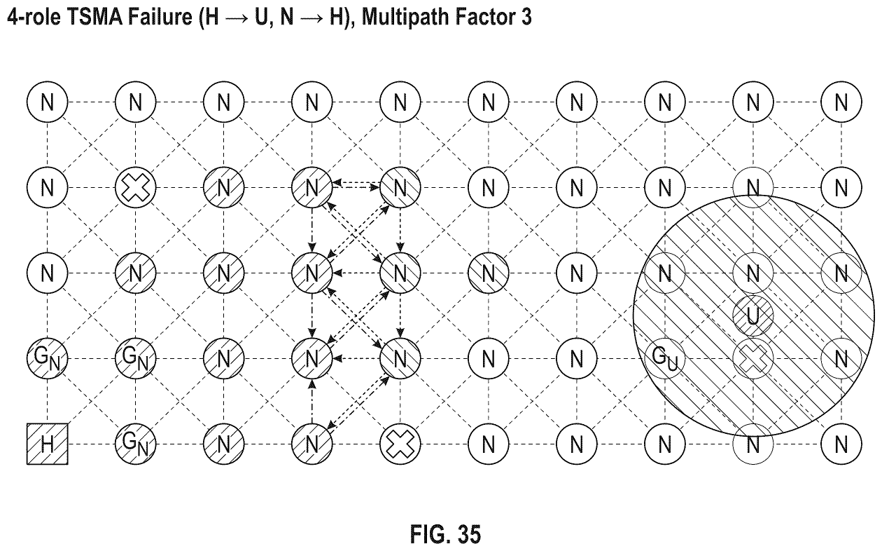

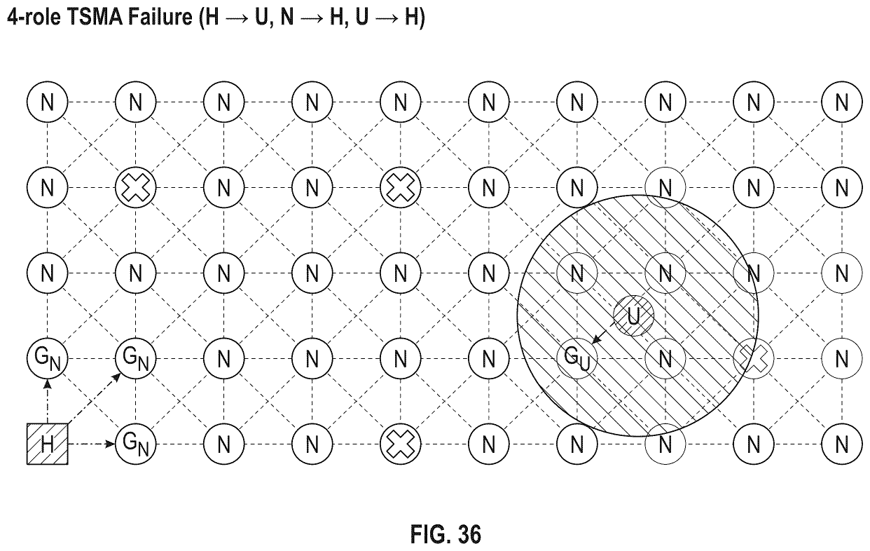

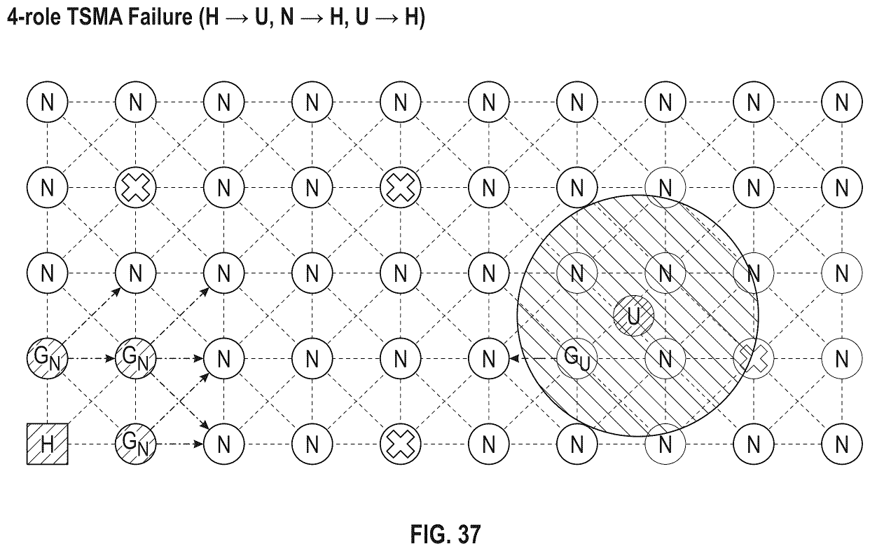

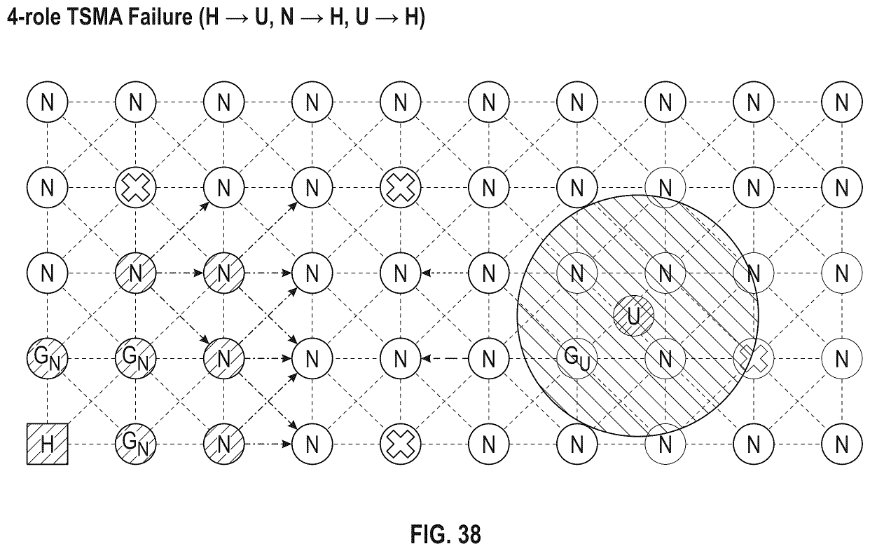

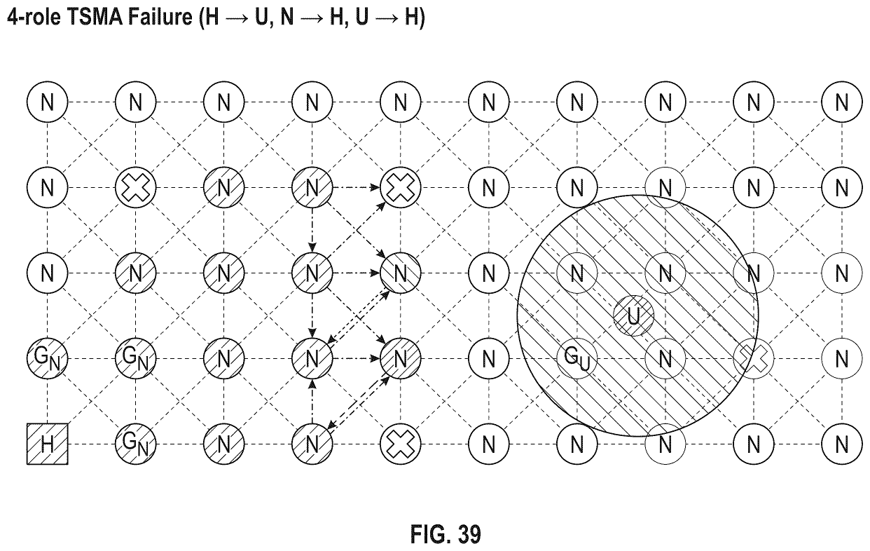

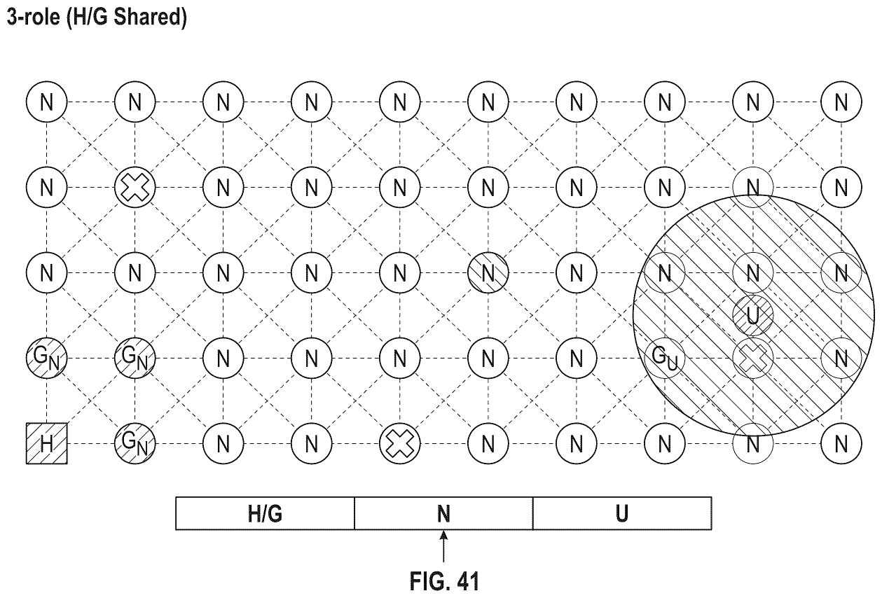

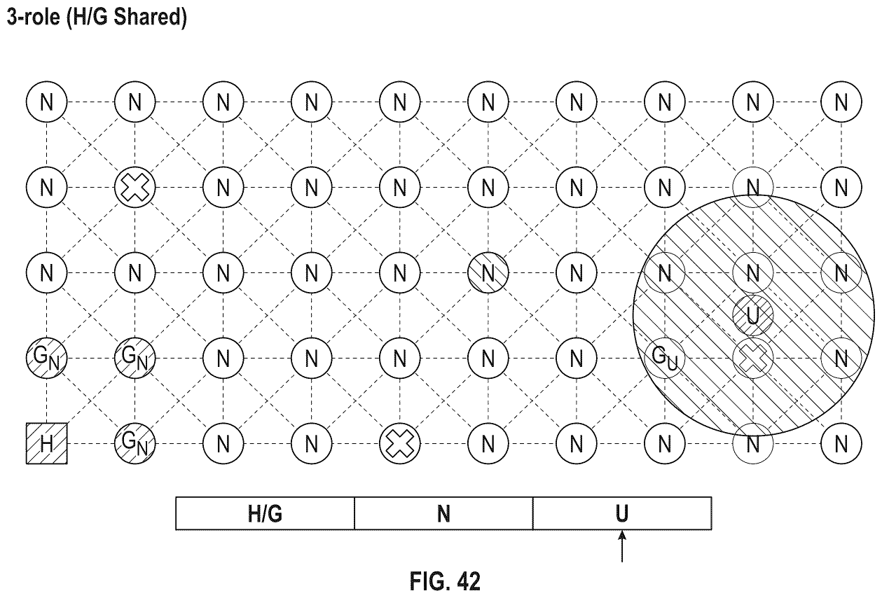

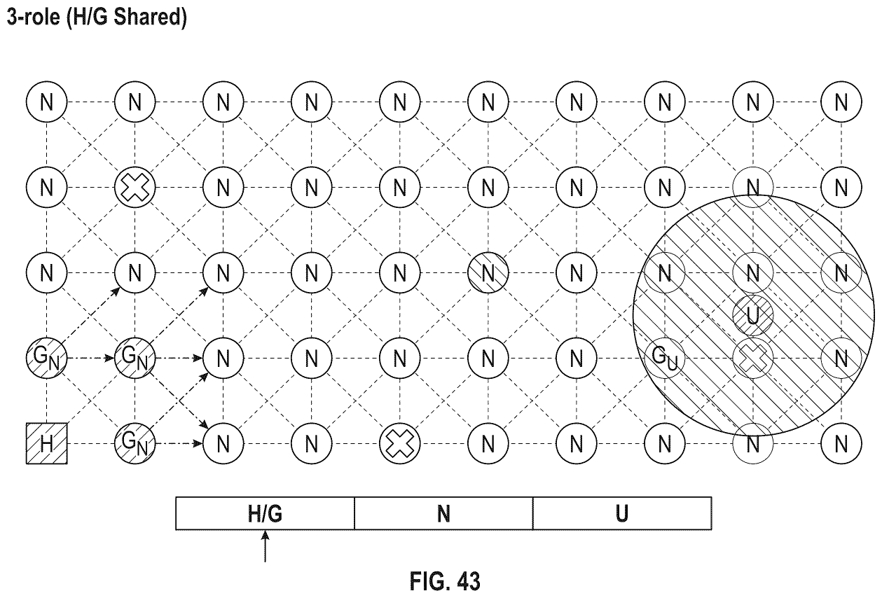

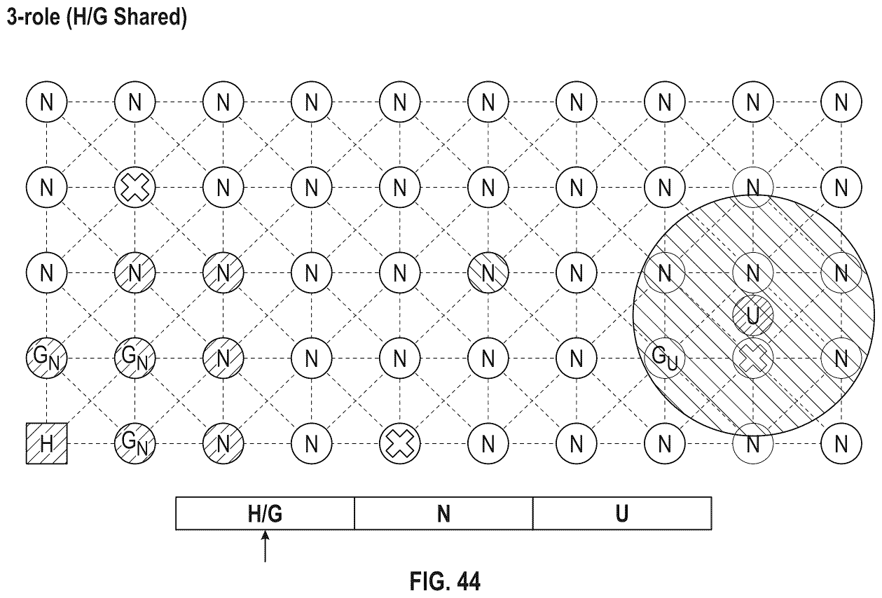

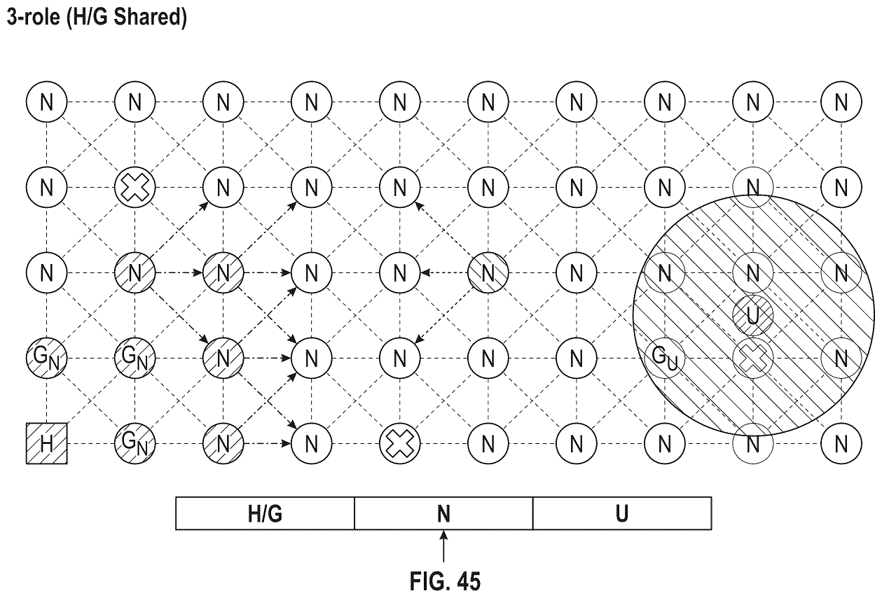

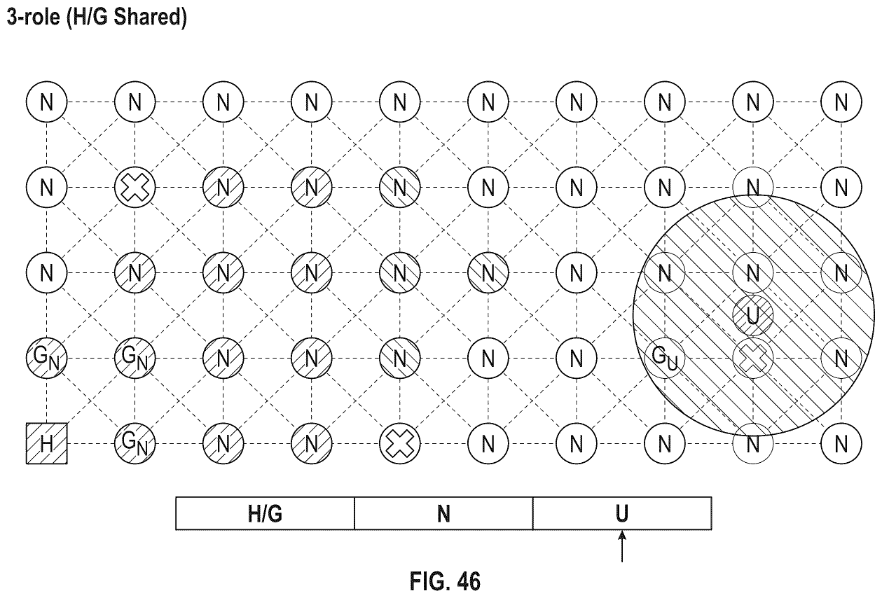

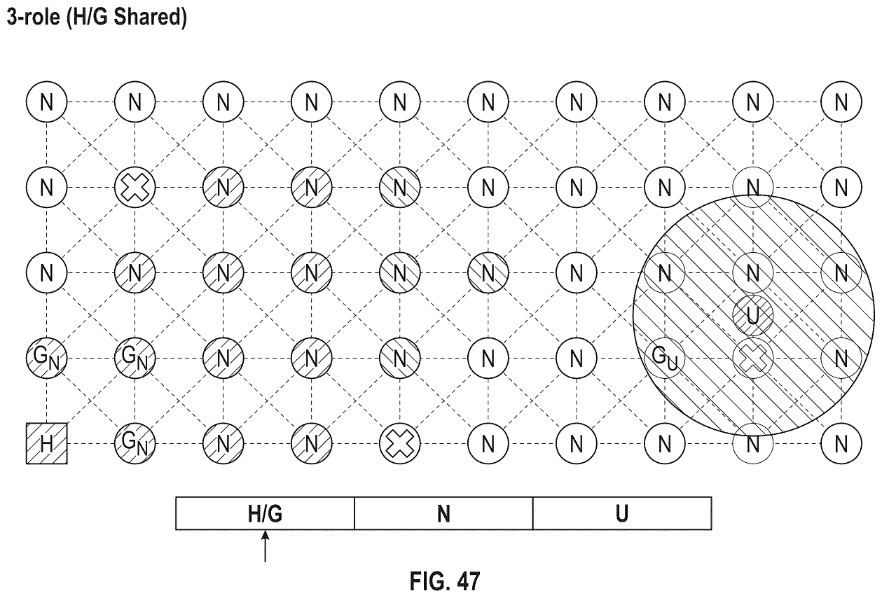

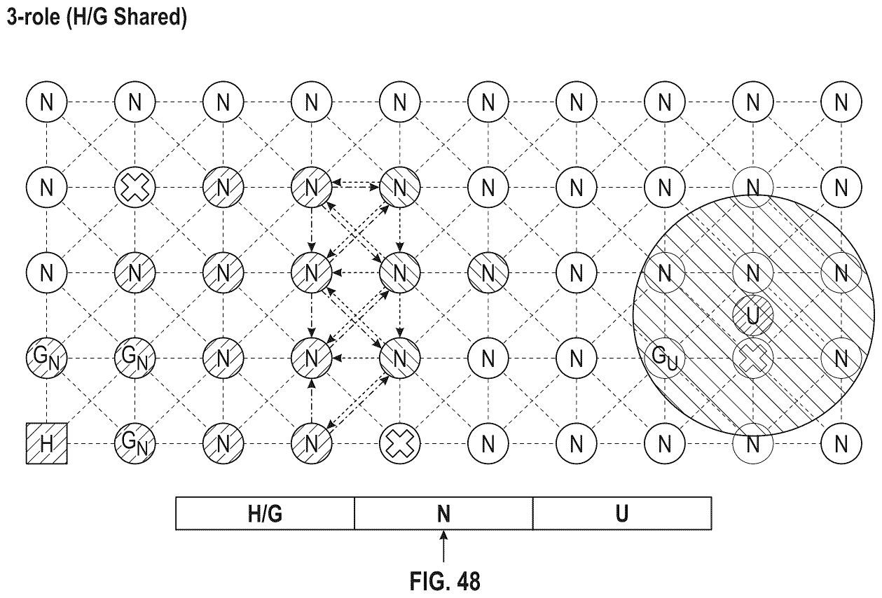

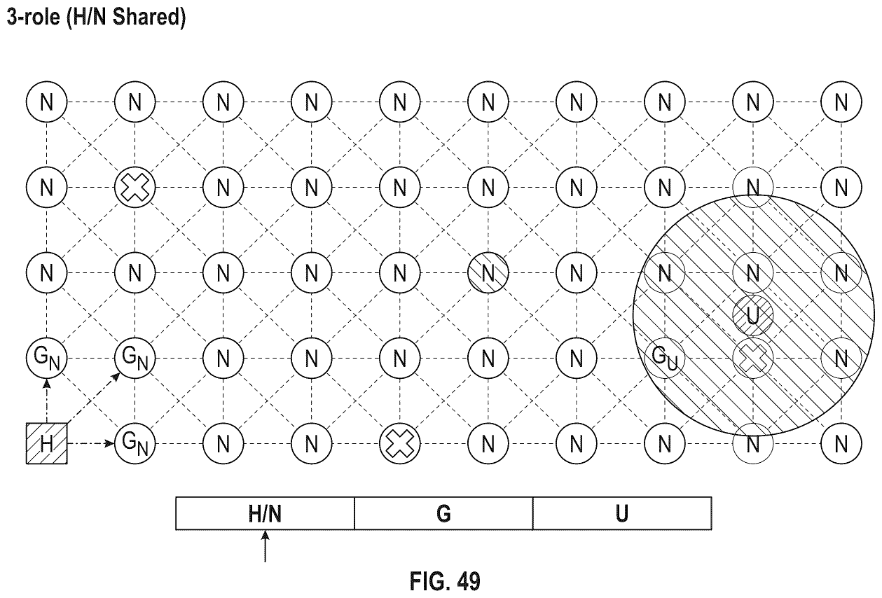

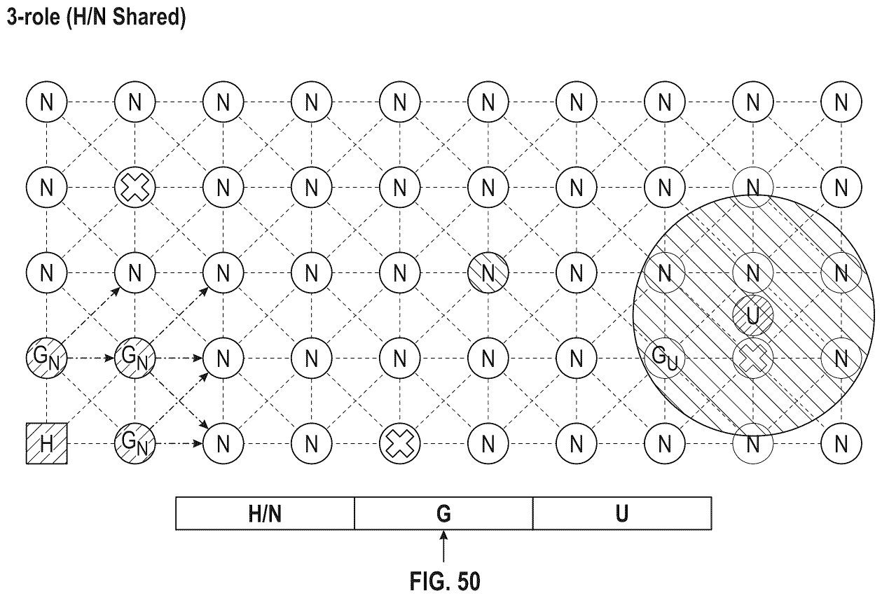

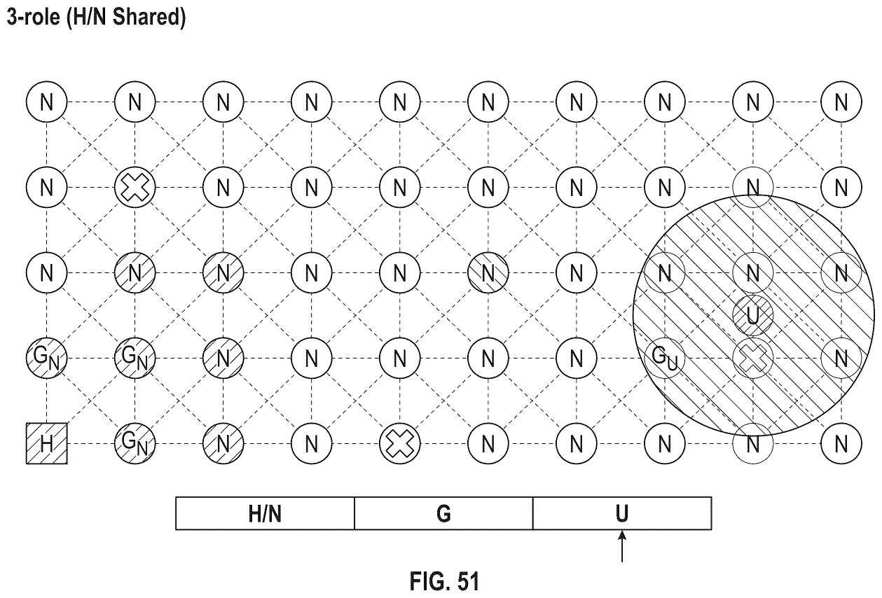

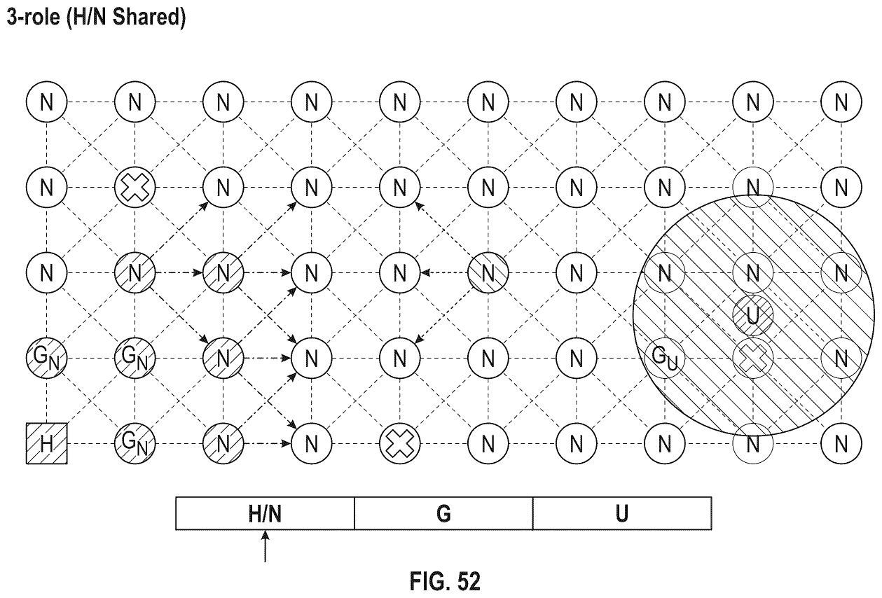

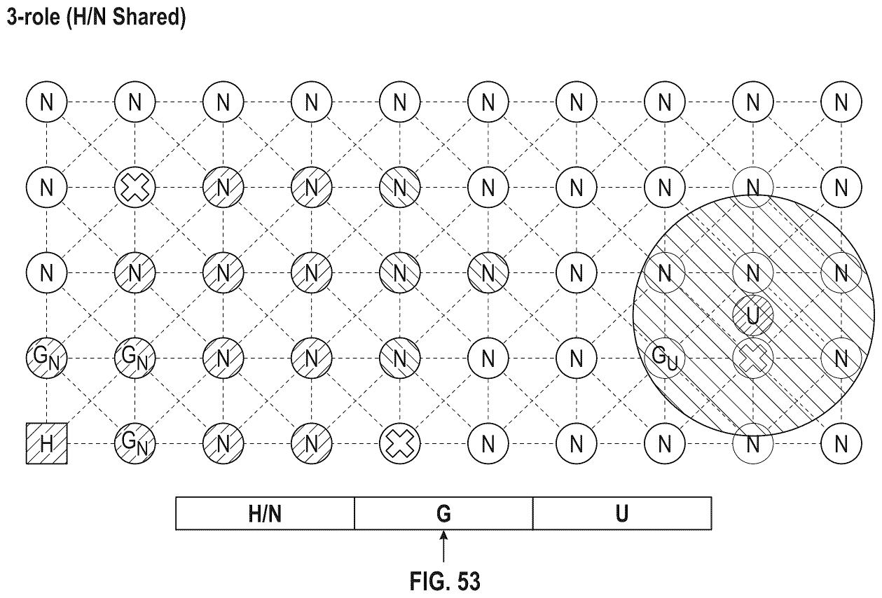

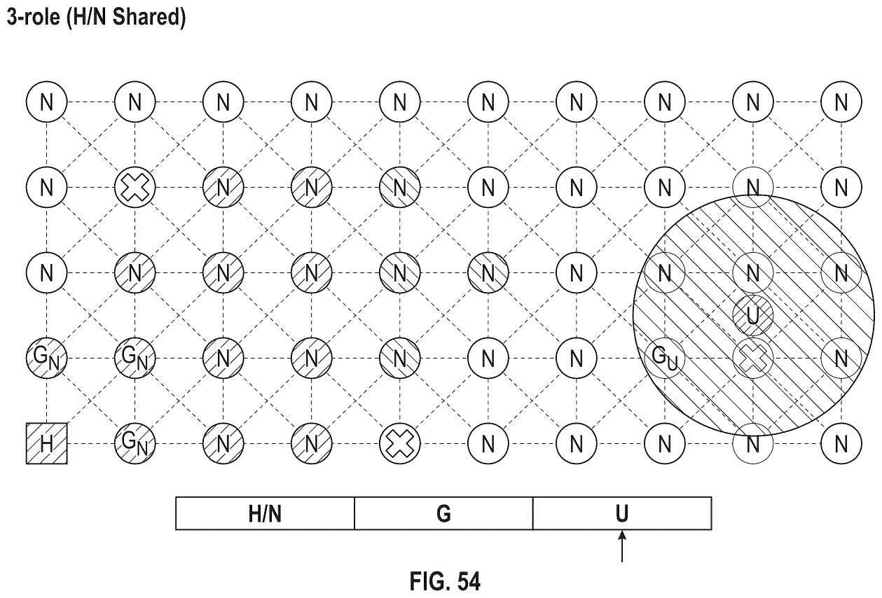

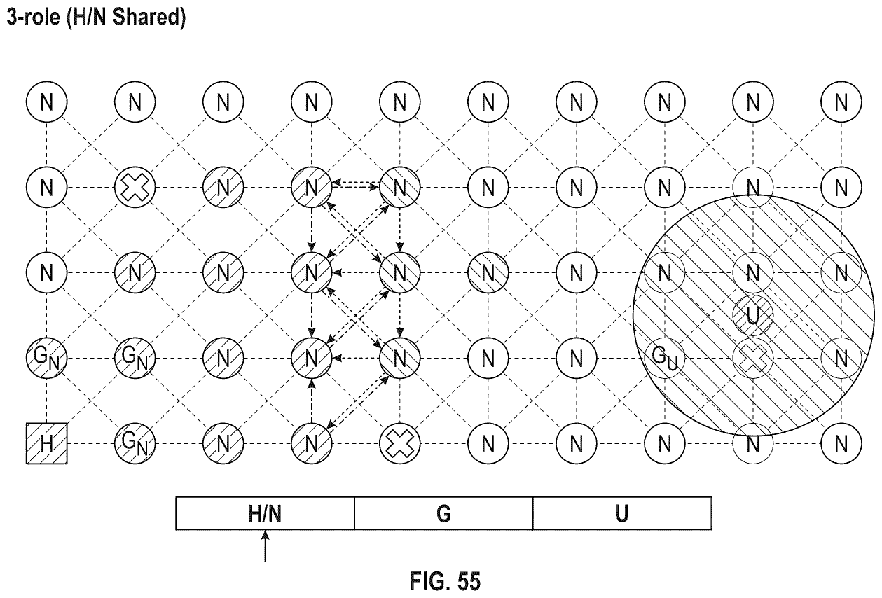

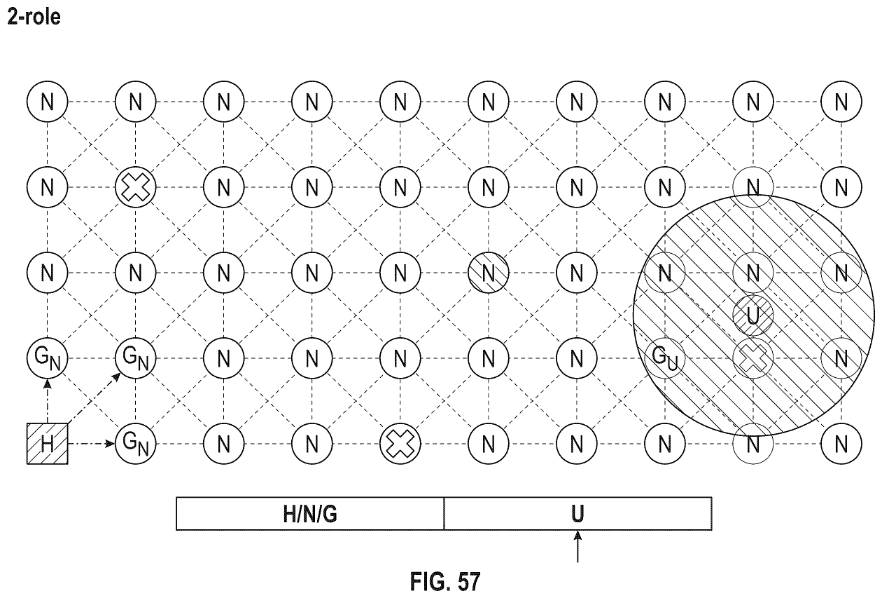

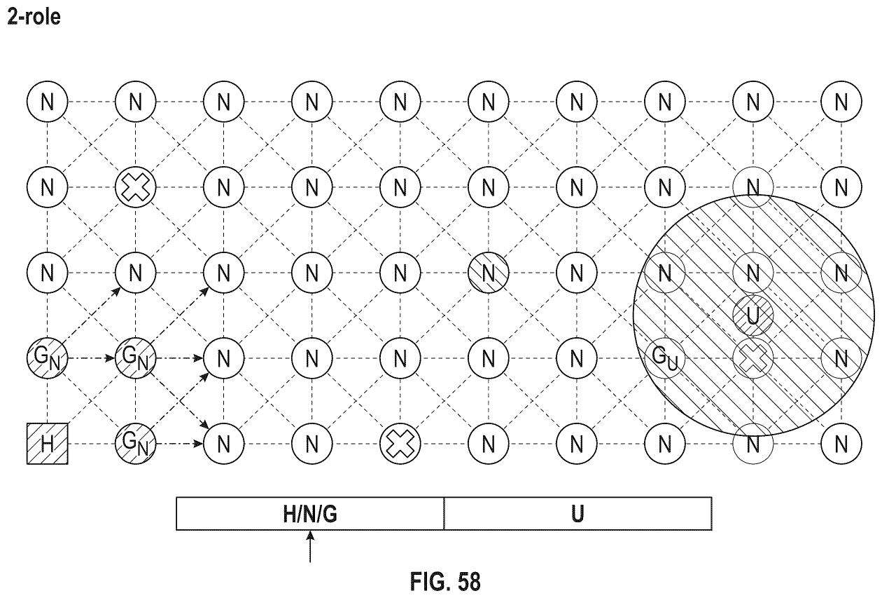

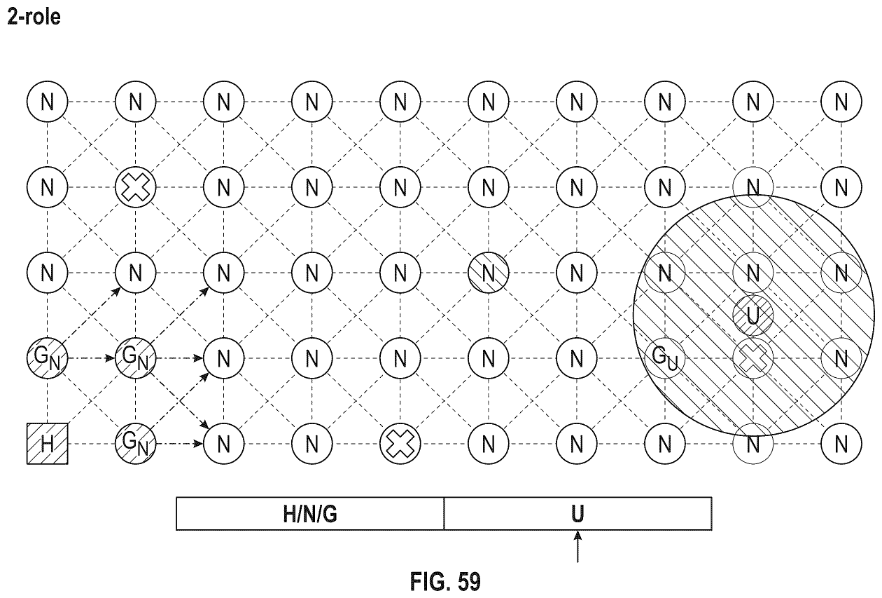

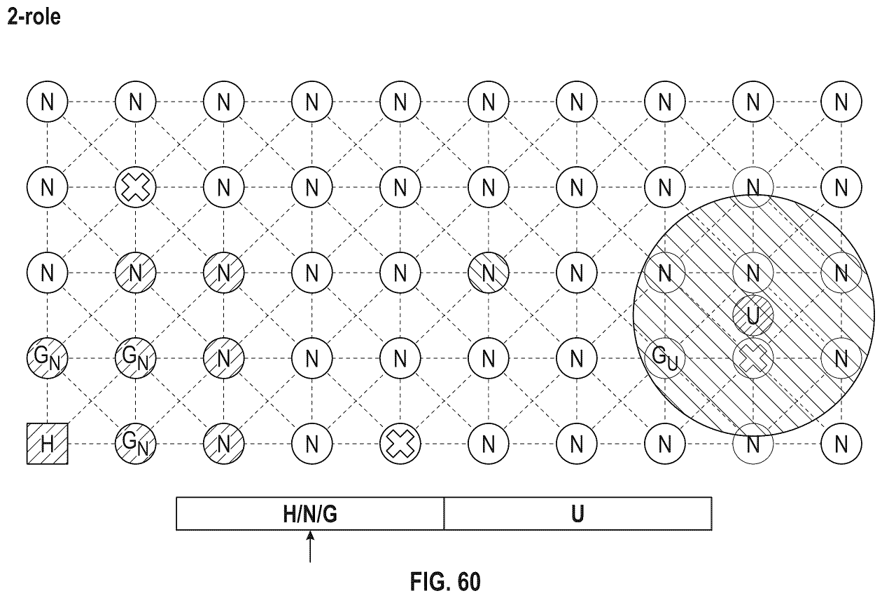

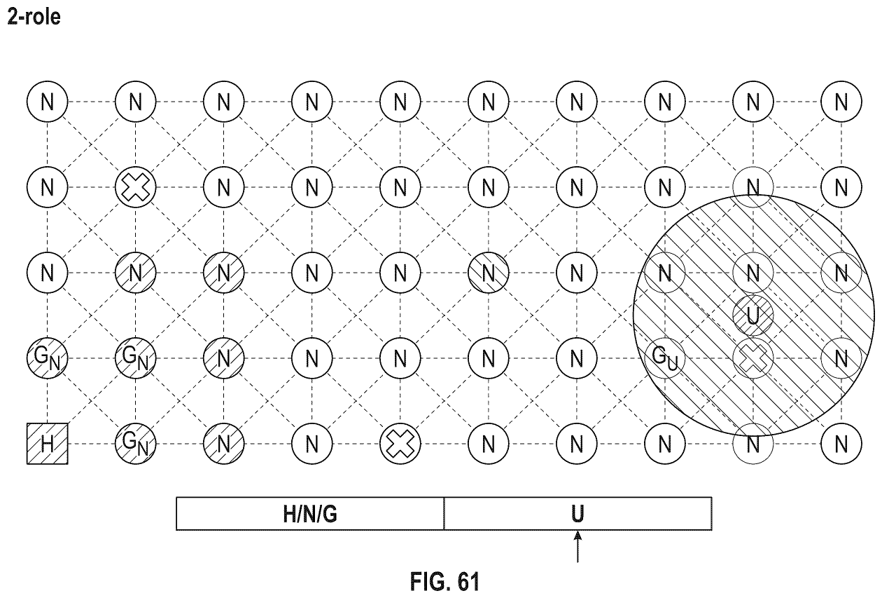

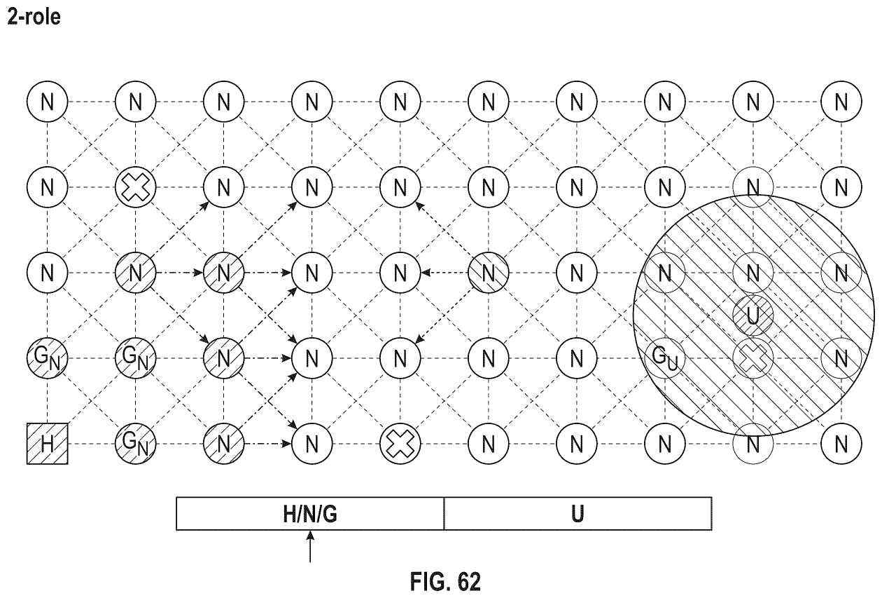

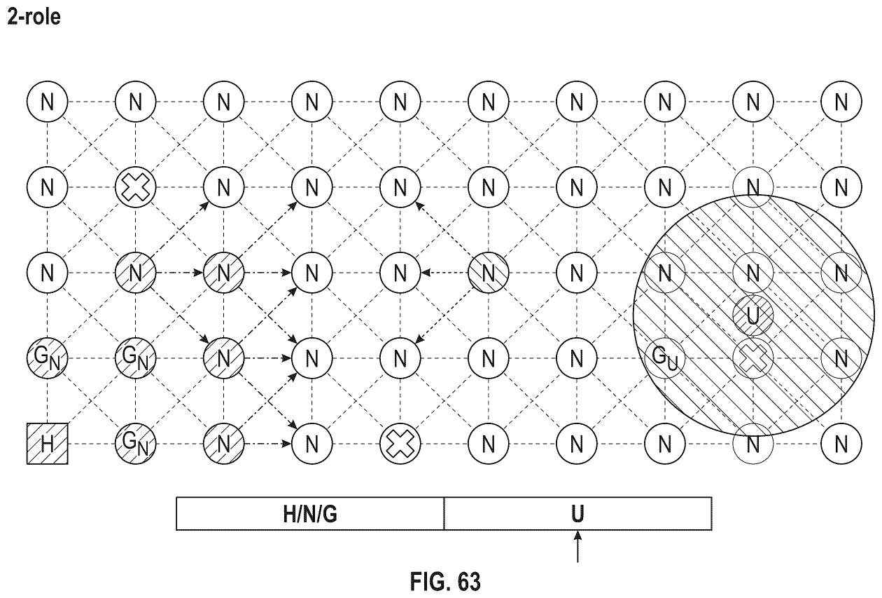

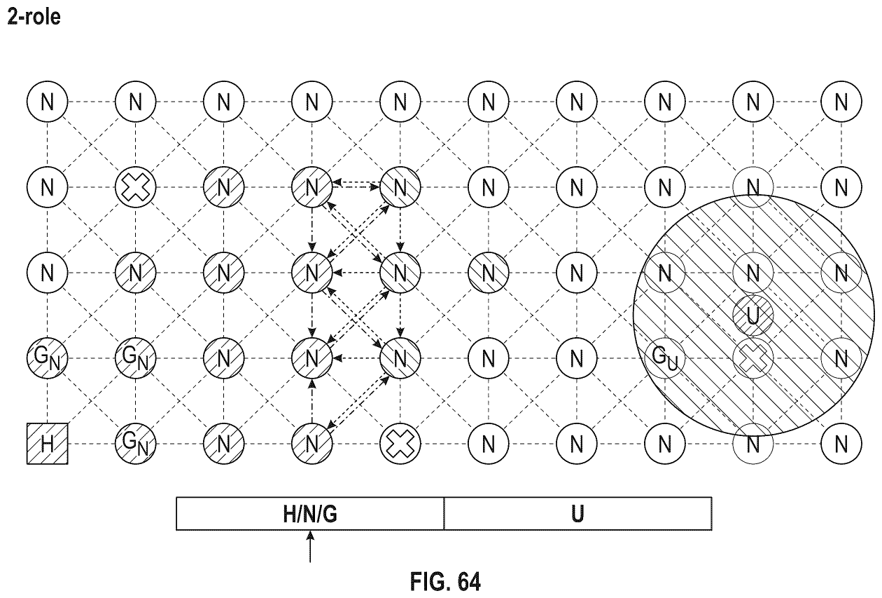

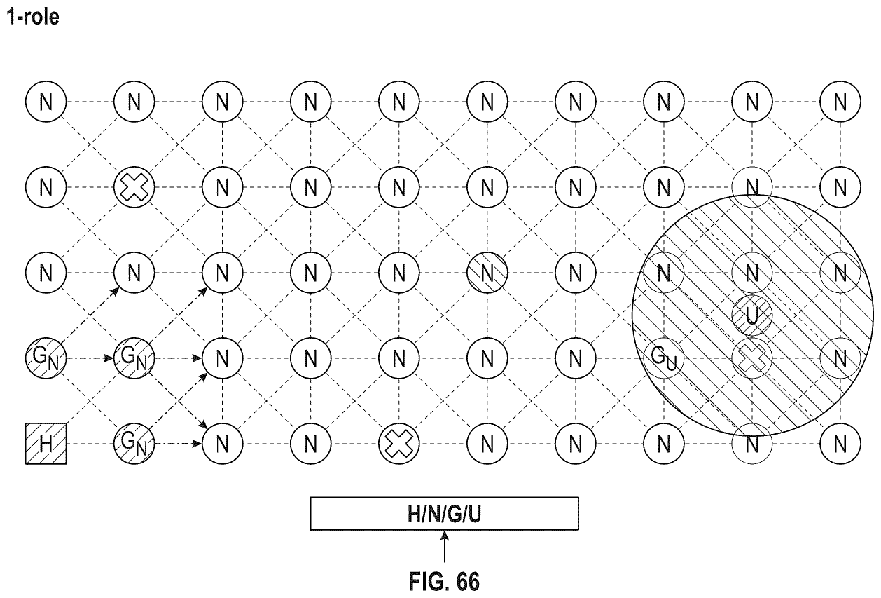

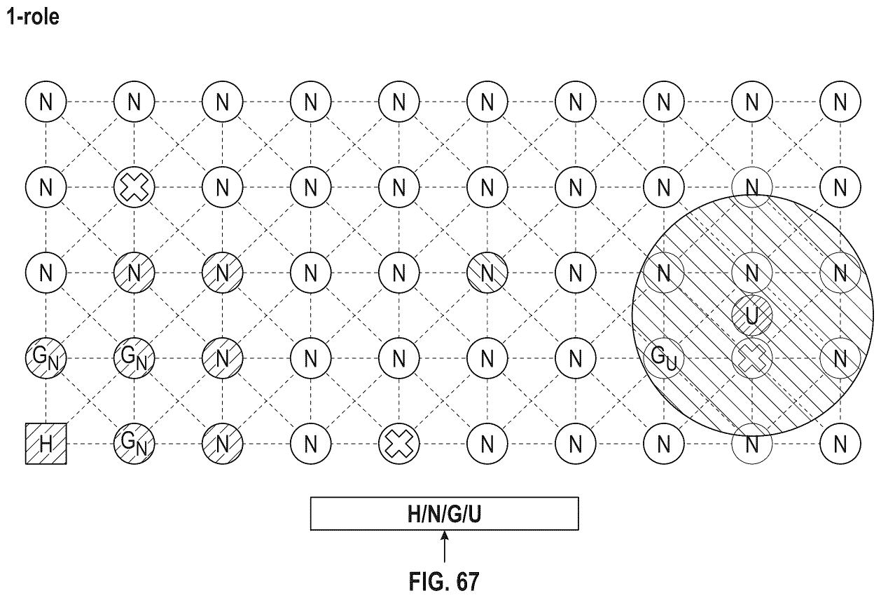

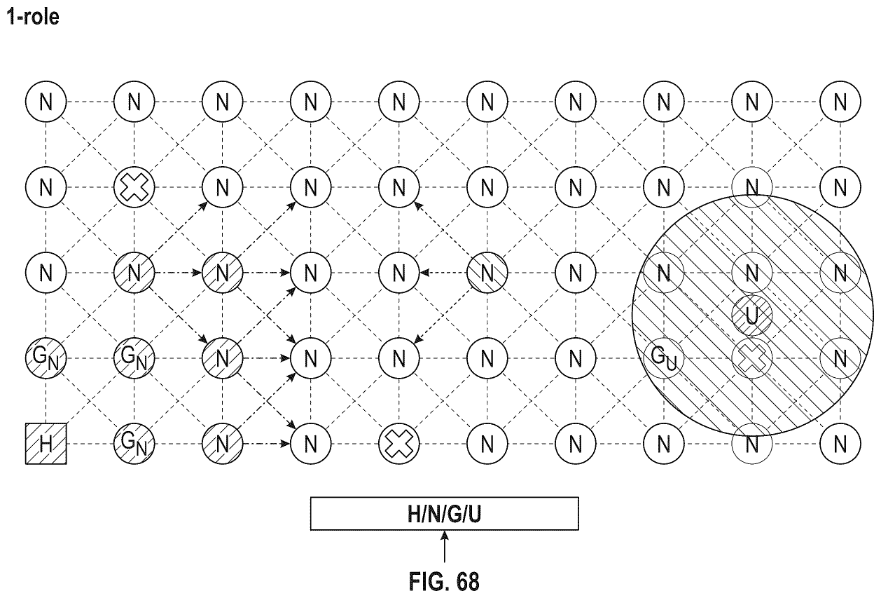

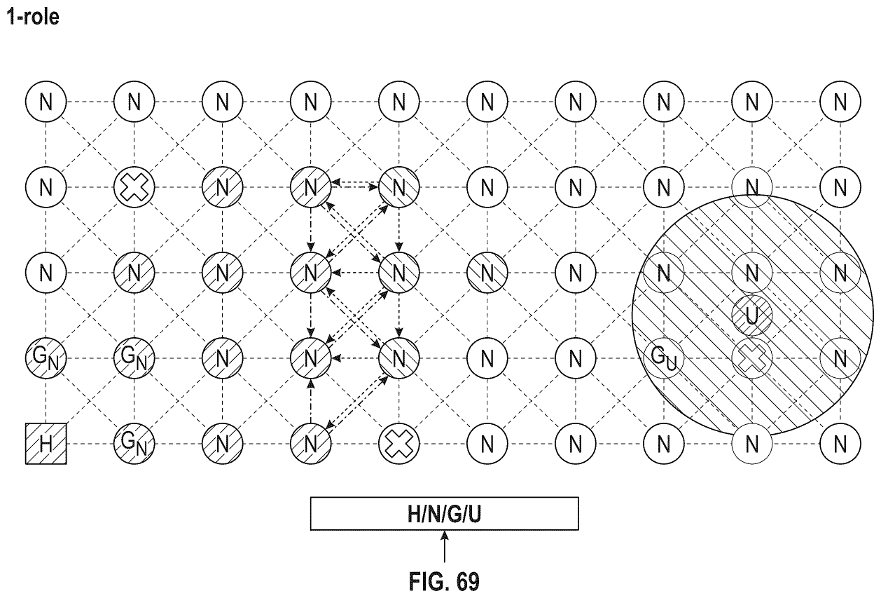

FIGS. 30 through 69 illustrate failure cases in some other approaches.

FIG. 30 through FIG. 39 illustrate example aspects of TSMA failures and/or of TILTSMA for 4-role in accordance with one or more embodiments of the present disclosure.

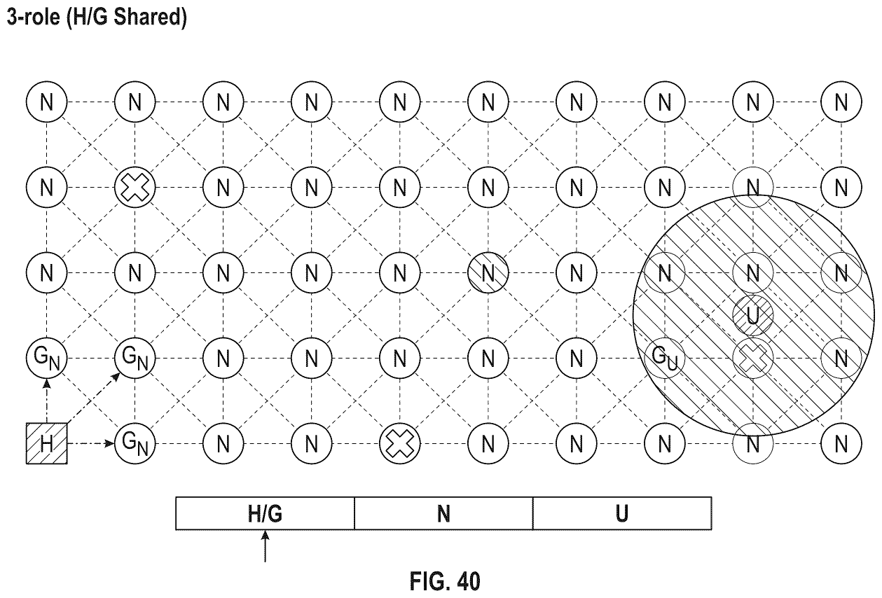

FIG. 40 through FIG. 55 illustrate example aspects of TSMA failures and/or of TILTSMA for 3-role in accordance with one or more embodiments of the present disclosure.

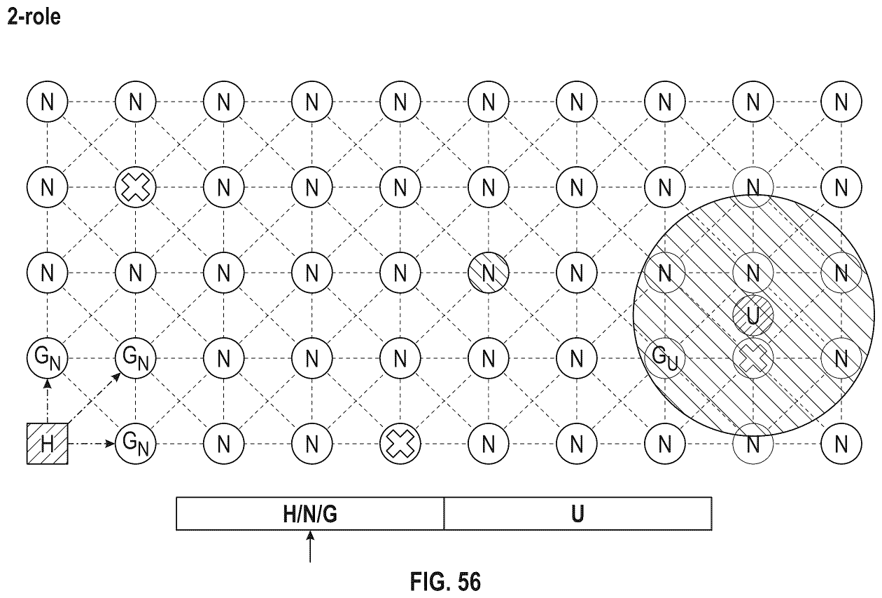

FIG. 56 through FIG. 64 illustrate example aspects of TSMA failures and/or of TILTSMA for 2-role in accordance with one or more embodiments of the present disclosure.

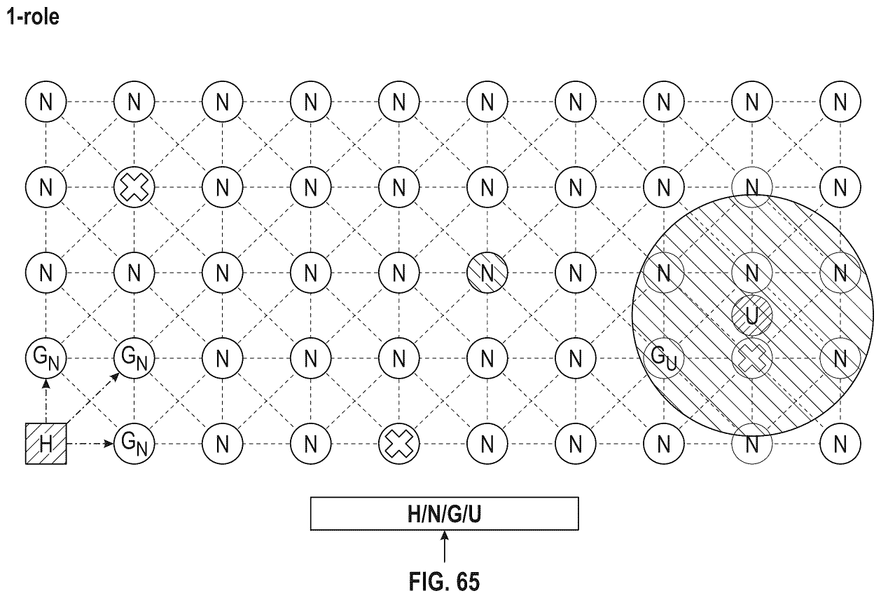

FIG. 65 through FIG. 69 illustrate example aspects of TSMA failures and/or of TILTSMA for 1-role in accordance with one or more embodiments of the present disclosure.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

What is claimed is:

1. A method of transmitting data to a destination node over a communications network, comprising:
transmitting, by a first node during a first instance of a first timeslot allocated to the first node from among a set of timeslots, a reservation associated with transmitting a set of data packets to the destination node;
transmitting, by a second node during a first instance of a second timeslot allocated to the second node from among the set of timeslots, the reservation to one or more relay nodes which are within a threshold distance of the second node from among relay nodes of the communications network;
temporarily reallocating resources from the one or more relay nodes to the first node based on the reservation, wherein the resources are associated with a third timeslot among the set of timeslots;
transmitting, by the first node during a first instance of the third timeslot, a first data packet of the set of data packets to the second node;
transmitting, by the second node during a second instance of the second timeslot, the first data packet to a first relay node comprised among the relay nodes of the communications network; and
transmitting, by the first relay node during a second instance of the third timeslot, the first data packet toward the destination node.

2. The method of claim 1, wherein:
the resources which are temporarily reallocated from the one or more relay nodes to the first node based on the reservation are further associated with a fifth timeslot among the set of timeslots; and
the method further comprises transmitting, by the first node during a first instance of the fifth timeslot, a second data packet of the set of data packets to the second node.

3. The method of claim 2, further comprising:
transmitting, by a second relay node comprised among the relay nodes of the communications network during a second instance of the fifth timeslot, the first data packet toward the destination node,
transmitting, by the second node during a third instance of the second timeslot, the second data packet to the first relay node;
transmitting, by the first relay node during a third instance of the third timeslot, the second data packet toward the destination node; and
transmitting, by a third relay node comprised among the relay nodes of the communications network during the third instance of the third timeslot, the first data packet toward the destination node.

4. The method of claim 2, wherein the reservation comprises an indication of a quantity of instances of the third timeslot and a quantity of instances of the fifth timeslot for which the resources are to remain reallocated to the first node.

5. The method of claim 1, further comprising reallocating the resources to the one or more relay nodes, after the first node has completed transmitting the set of data packets to the second node.

6. The method of claim 1, further comprising transmitting, by the first node during a second instance of the first timeslot, a final data packet of the set of data packets to the second node.

7. The method of claim 1, further comprising transmitting, by a further relay node which is comprised among the relay nodes of the communications network and neighbors the destination node, the first data packet to the destination node, wherein:
the transmitting of the first data packet by the first node to the second node is according to a first communications protocol;
the transmitting of the first data packet by the second node to the first relay node is according to a second communications protocol different from the first communications protocol; and
the transmitting of the first data packet by the further relay node to the destination node is according to the first communications protocol.

8. The method of claim 1, further comprising transmitting, by the second node during the first instance of the second timeslot, an acknowledgement message to the first node with respect to the reservation.

9. The method of claim 1, further comprising:
transmitting, by a relay node which is comprised among the relay nodes of the communications network and neighbors the destination node, a data packet of the set of data packets during a subsequent instance of the third timeslot or a subsequent instance of a fifth timeslot among the set of timeslots; and
receiving, by the destination node, the data packet.

10. A system comprising:
a first node;
a second node;
a destination node; and
a communications network comprising relay nodes, wherein the relay nodes are between the second node and the destination node;
wherein:
the first node is configured to transmit, during a first instance of a first timeslot allocated to the first node from among a set of timeslots, a reservation associated with transmitting a set of data packets to the destination node;
the second node is configured to transmit, during a first instance of a second timeslot allocated to the second node from among the set of timeslots, the reservation to one or more relay nodes which are within a threshold distance of the second node from among the relay nodes of the communications network;
the one or more relay nodes are configured to temporarily reallocate resources to the first node based on the reservation, wherein the resources are associated with a third timeslot among the set of timeslots;
the first node is further configured to transmit, during a first instance of the third timeslot, a first data packet of the set of data packets to the second node;
the second node is further configured to transmit, during a second instance of the second timeslot, the first data packet to a first relay node comprised among the relay nodes of the communications network; and
the first relay node is further configured to transmit, during a second instance of the third timeslot, the first data packet toward the destination node.

11. The system of claim 10, wherein:
the resources which are temporarily reallocated from the one or more relay nodes to the first node based on the reservation are further associated with a fifth timeslot among the set of timeslots; and
the first node is configured to transmit, during a first instance of the fifth timeslot, a second data packet of the set of data packets to the second node.

12. The system of claim 11, wherein:
a second relay node comprised among the relay nodes of the communications network is configured to transmit, during a second instance of the fifth timeslot, the first data packet toward the destination node;
the second node is configured to transmit, during a third instance of the second timeslot, the second data packet to the first relay node;
the first relay node is configured to transmit, during a third instance of the third timeslot, the second data packet toward the destination node; and
a third relay node comprised among the relay nodes of the communications network is configured to transmit, during the third instance of the third timeslot, the first data packet toward the destination node.

13. The system of claim 11, wherein the reservation comprises an indication of a quantity of instances of the third timeslot and a quantity of instances of the fifth timeslot for which the resources are to remain reallocated to the first node.

14. The system of claim 10, wherein the resources are reallocated to the one or more relay nodes, after the first node has completed transmitting the set of data packets to the second node.

15. The system of claim 10, wherein the first node is configured to transmit, during a second instance of the first timeslot, a final data packet of the set of data packets to the second node.

16. The system of claim 10, wherein a further relay node which is comprised among the relay nodes of the communications network and neighbors the destination node is configured to transmit the first data packet to the destination node, wherein:
the transmitting of the first data packet by the first node to the second node is according to a first communications protocol;
the transmitting of the first data packet by the second node to the first relay node is according to a second communications protocol different from the first communications protocol; and
the transmitting of the first data packet by the further relay node to the destination node is according to the first communications protocol.

17. The system of claim 10, wherein the second node is configured to transmit, during the first instance of the second timeslot, an acknowledgement message to the first node with respect to the reservation.

18. The system of claim 10, wherein:
a relay node which is comprised among the relay nodes of the communications network and neighbors the destination node is configured to transmit a data packet of the set of data packets during a subsequent instance of the third timeslot or a subsequent instance of a fifth timeslot among the set of timeslots; and
the destination node is configured to receive the data packet.

19. The system of claim 10, wherein:
the first node is configured to exchange data with the second node using a first communications protocol;
the second node and the relay nodes are configured to exchange data with one another using a second communications protocol different from the first communications protocol; and
a relay node comprised among the relay nodes is configured to exchange data with the destination node using the first communications protocol.
